(19) United States
(12) Patent Application Publication
(10) Pub. No.: US 2026/0264991 A1
(43) Pub. Date: Sep. 10, 2026

(54) IMPROVED LOADING STATION FOR LOADING GOODS INTO LOADING AIDS, STORAGE SYSTEM HAVING A LOADING STATION OF THIS TYPE AND OPERATING METHOD FOR A LOADING STATION OF THIS TYPE

(71) Applicant: TGW Logistics GmbH, Marchtrenk (AT)

(72) Inventors: Ramón MARTÍNEZ VALDIVIA, Madrid (ES); Alberto SANCHIS SEBASTIÁ, Linz (AT); Gerald KETTLGRUBER, Linz (AT)

(73) Assignee: TGW Logistics GmbH, Marchtrenk (AT)

(21) Appl. No.: 19/474,269

(22) PCT Filed: Apr. 13, 2024
(86) PCT No.: PCT/AT2024/060147

§ 371 Date: Dec. 12, 2025

(30) Foreign Application Priority Data
Apr. 14, 2023 (AT) A50274/2023

(51) Int. Cl. B65G 1/137; B65G 1/04

(52) U.S. Cl. CPC B65G 1/1378; B65G 1/0492

(57) ABSTRACT

A loading station for loading a loading aid with an article includes a driving zone for autonomous transport vehicles, the driving zone being delimited by intersecting planes. The loading station also includes a lifting device for the loading aids and a loading device for loading articles into loading aids. The loading station further includes conveying systems for transporting loading aids and articles, which connect the lifting device with the loading device. The conveying systems are arranged above the driving zone. Moreover, the height of the driving zone corresponds at least to a clearance height for a transport vehicle loaded with a loading aid. Furthermore, a storage system has such a loading station and a method operates such a loading station.

The invention relates to a loading station for loading loading aids with articles, wherein the loading station comprises a driving zone in which autonomously movable, driverless transport vehicles for transporting loading aids are movable. The loading station also comprises a ground plane and a cover plane opposite the ground plane at a vertical spacing, wherein the ground plane and the cover plane delimit the driving zone in a vertical direction. The loading station further comprises a first boundary plane and a second boundary plane opposite the first boundary plane at a horizontal spacing, each intersecting the ground plane and the cover plane, preferably at a right angle, and delimiting the driving zone in a horizontal direction. Furthermore, the loading station comprises a first conveying system for transporting loading aids (with or without articles) and a second conveying system for transporting articles (with or without loading aids). In addition, the loading station comprises a lifting system with a lifting device aligned with a side of the first boundary plane facing away from the driving zone for transferring loading aids (with or without transport vehicles) between a loading aid handover location arranged on the lifting device below the cover plane, in particular in the driving zone, and the first conveying system. Furthermore, the loading station comprises a loading device aligned with a side of the second boundary plane facing away from the driving zone for loading loading aids with articles provided at the loading station. The first conveying system and the second conveying system thereby each extend between the first and second boundary planes, in particular from the first to the second boundary plane, and the first conveying system connects the lifting device with the loading device.

The invention also relates to a loading station group comprising a plurality of loading stations of the aforementioned type arranged one next to the other, wherein the driving zones of the loading stations are connected with one another.

The invention further relates to a storage system comprising a storage zone in which an article storage is arranged, an order processing zone in which at least one loading station is arranged, and a storage and retrieval conveying system for transporting an article between the storage zone and the order processing zone. The loading station is thereby configured as described above, and the second conveying system of the loading station is connected with the article storage by the storage and retrieval conveying system.

Finally, the invention relates to a method for loading loading aids with articles using a loading station of the aforementioned type.

A loading station, a loading station group, a storage system and a method of the stated type are fundamentally known in the prior art. Loading aids are thereby transported by a first conveying system and articles by a second conveying system to a loading station, where the article is loaded into the loading aid. The disadvantage of the known systems is that they require a comparatively large amount of space and thus the floor area of a building in which such a system is installed is relatively large. Correspondingly, the costs for such a building are also comparatively high, namely not only for the construction of the building but also for its operation. The latter is true in particular for heating costs due to the relatively large cubic volume of such buildings.

One object of the invention is thus to provide an improved loading station, an improved loading station group, an improved storage system and an improved method for loading loading aids. In particular, it shall be possible to reduce the floor area required for the processes in a storage system while maintaining the same capacity.

The object of the invention is solved by a loading station of the type mentioned at the beginning, in which
the vertical spacing between the ground plane and the cover plane corresponds at least to a clearance height for transport vehicles each loaded with a loading aid, and
the first conveying system and the second conveying system are arranged above the driving zone.

The object of the invention is also solved by a loading station group comprising a plurality of loading stations of the aforementioned type arranged one next to the other, wherein the driving zones of the loading stations, in particular driving surfaces of the driving zones, are connected with one another.

Moreover, the object of the invention is solved with a storage system of the type mentioned at the beginning, in which the loading station has the aforementioned construction, and the second conveying system of the loading station is connected with the article storage by the storage and retrieval conveying system.

Finally, the object of the invention is solved with a method for loading loading aids with articles using a loading station of the stated type, having the following steps:
i) transporting an article to the loading device using the second conveying system;
ii) providing the article at the loading device, in particular at a removal location of the article provisioning device;
iii) transporting a loading aid to the lifting device using an autonomously movable, driverless transport vehicle, wherein the transport vehicle is moved over the driving zone of the loading station to the loading aid handover location;
iv) transferring the loading aid from the loading aid handover location to the first conveying system using the lifting device, in particular using a lifting unit of the lifting device;
v) transporting the loading aid from the lifting device to the loading device using the first conveying system;
vi) providing the loading aid at the loading device, in particular at a loading location of the loading aid provisioning device;
vii) loading the loading aid provided in step vi) with the article provided in step ii) according to an order;
viii) transporting the loading aid loaded with an article using the first conveying system away from the loading device;
ix) transporting the loading aid loaded with an article to the lifting device using the first conveying system;
x) transferring the loading aid loaded with an article from the first conveying system to the loading aid handover location using the lifting device;
xi) transporting the loading aid loaded with an article away from the lifting device using an autonomously movable, driverless transport vehicle, wherein the transport vehicle is moved away from the loading aid handover location over the driving zone of the loading station.

In step vii), an article can be removed from the removal location by a picker or by a loading robot, for example from a (different) loading aid provided at the removal location and containing an article, and then be transferred into the loading aid provided at the loading location.

The proposed measures reduce the floor area required for the processes in a storage system while maintaining the same capacity of the storage system. This is achieved by making the area below the first and second conveying system available as a driving zone for autonomous transport vehicles. Since these transport vehicles are rather low even in a loaded state, a minor lift of the first and second conveying system is sufficient to achieve the claimed effect.

The ground plane and the cover plane can be inclined in relation to one another or be aligned parallel to one another. It is particularly preferable for the ground plane and the cover plane to each be aligned horizontally. Analogously, the first and second boundary planes can be inclined in relation to one another or be aligned parallel to one another. Preferably, the first and second boundary planes are each aligned vertically. It is advantageous for the driving zone to thereby be quadrilateral in vertical section, in particular trapezoidal, parallelogram-shaped, rectangular, or square.

It is favorable for the loading station to further have a third boundary plane and a fourth boundary plane opposite the third boundary plane at a horizontal spacing, each intersecting the ground plane, the cover plane and the first and second boundary planes, preferably at a right angle, and delimiting the driving zone in a further horizontal direction. It is particularly preferable for the third and fourth boundary planes to be aligned vertically. The driving zone can thus have a parallelepiped shape, in particular a cuboid or cube.

The clearance height preferably corresponds at least to a height of the transport vehicle with one loading aid placed thereon, a plurality of loading aids placed one next to the other thereon, or a plurality of stacked loading aids, optionally together with an article protruding beyond the loading aid(s). Preferably, the clearance height is at least 1 m and/or maximum 2 m, particularly preferably maximum 1.5 m.

Further advantageous embodiments and developments of the invention can be derived from the dependent claims as well from the description in connection with the figures.

It is advantageous for the driving zone to comprise a driving surface drivable on by transport vehicles, preferably forming a closed circulation. The transport vehicles can thereby be moved particularly well in an ordered fashion in the driving zone.

Preferably, the transport vehicles can drive on the driving surface in one driving direction, or rather the transport vehicles preferably only move along the driving surface in one driving direction. If the driving surface forms a closed circulation, the driving direction corresponds to a circulation direction. This is also advantageous in the case of a loading station group having a plurality of loading stations arranged one next to the other. Specifically, it is thereby preferably provided that the driving surfaces of the driving zones of the loading stations are connected with one another and form a closed circulation, wherein the closed circulation extends across all loading stations of the loading station group. The driving surfaces are preferably connected with one another by their coupling zones.

The driving surface can be arranged on a floor of a storage system, for example on a floor of a story of the storage system. Optionally, the loading station can also comprise a lower platform arranged in the ground plane. The loading station can be installed on this platform and/or the driving surface of the driving zone can be arranged thereon. For example, the support structures described in the following can be positioned on this platform.

It is particularly preferable for the driving zone to be configured as an open container, wherein a base plate of the container forms the platform and a cover plate of the container a driving platform.

It is particularly advantageous for the driving zone to comprise a further driving surface, preferably forming a closed circulation, drivable on by transport vehicles, the further driving surface being arranged, in particular with a constant spacing to the driving surface, extending next to the driving surface and being connected to the driving surface at at least one point by a changeover driving surface, wherein the driving surface and the further driving surface are spaced apart from one another in such a way that transport vehicles moving along the driving surface and the further driving surface can pass one another. The transport vehicles can thus overtake one another, thereby achieving a particularly efficient conveying process. Preferably, the driving surface and/or the further driving surface are thereby drivable on in one, in particular in the same, driving direction. If the driving surface and/or the further driving surface each form a closed circulation, the driving direction corresponds to a respective circulation direction.

For example, the driving zone can have a driving area arranged in the ground plane, on which driving area the transport vehicles are movable, wherein the driving surface and/or the further driving surface are arranged on the driving area of the driving zone.

In a further embodiment variation, it can be provided that the driving surface of the driving zone and/or the further driving surface of the driving zone traverses the first conveying system, preferably at a right angle. It is particularly preferable for the driving surface and/or the further driving surface of the driving zone to traverse a driving surface of the first conveying system arranged on a driving platform as described in the following. A compact loading station construction is thereby possible.

It is favorable for the driving zone to have a provisioning driving surface diverging from the driving surface of the driving zone at a point of exit and merging into the driving surface of the driving zone at a point of entry for providing transport vehicles at the loading aid handover location, wherein the provisioning driving surface extends from the point of exit to the loading aid handover location and from the loading aid handover location to the point of entry. The transport vehicles can thereby move to the loading aid handover location and stop there without impeding traffic on the driving surface.

It is also advantageous for the driving surface and/or the further driving surface of the driving zone to each have a coupling zone which is connectable with a coupling zone of a, in particular structurally identical, further loading station arranged next to the loading station. A plurality of loading stations can thereby be arranged in a row in a simple manner, or in other words, a modular structure of a loading station group is thereby achieved.

The coupling zone preferably borders the previously described third or fourth boundary plane. It is particularly preferable for a first coupling zone to border the third boundary plane and a second coupling zone to border the fourth boundary plane. Driving surfaces of loading stations arranged one next to the other are thereby connected with each other if the loading stations are positioned in such a way that the third boundary plane of one of the loading stations adjoins the fourth boundary plane of another of the loading stations.

In a further embodiment variation, the loading device can have a loading aid provisioning device for providing loading aids at a loading location and/or an article provisioning device for providing articles (with or without loading aids) at a removal location. The loading aid or the article can thereby be provided at the loading device in a simple manner. It is thereby favorable for the provisioning devices to each be provided on a conveying device.

It is particularly advantageous for the loading aid provisioning device and the article provisioning device to be configured to provide loading aids and articles at a provisioning height, in particular an ergonomic height for manually loading the loading aids. Ergonomic working when loading the loading aid is thus achieved. In particular, the removal location and/or the loading location can be arranged at the (respective) provisioning height.

In a further embodiment variation, the loading station can have a working location for manually loading loading aids provided at the loading location with articles provided at the removal location. This thus enables loading of the loading aid by a (human) worker. It can thereby be provided that the removal location and/or the loading location is inclined in the direction of the working location in order to enable ergonomic access to the provided article and/or into the provided loading aid.

It is, however, also conceivable for the loading station to have a loading robot for automated loading of loading aids provided at the loading location with articles provided at the removal location. The loading aid can thereby be loaded with an article in an automated or automatic manner. It is particularly preferable for the loading station to comprise both a working location for manual loading and for a loading robot, wherein loading of the loading aid can be performed selectively by the loading robot or a picker. Optionally, the loading robot can also be provided as a collaborative robot (cobot) and be configured to work together with humans. In this case, loading can be performed substantially simultaneously by the loading robot and a picker.

It is advantageous for the first conveying system to comprise a stationary conveying system, preferably forming a closed circulation, for transporting loading aids between the first and second boundary planes, in particular between the lifting device and the loading device. For example, the stationary conveying device of the first conveying system can have a first conveying section extending from the first to the second boundary plane, in particular from the lifting device to the loading device, and a second conveying section extending from the second to the first boundary plane, in particular from the loading device to the lifting device. In a further embodiment, the stationary conveying device of the first conveying system can have a third conveying section connecting the first and second conveying sections, forming the loading aid provisioning device and the loading location.

The proposed measures can allow the transportation of a loading aid to and from the loading device in a simple manner, in particular where the stationary conveying device has a closed circulation. In addition, a third conveying section has a double function, since it serves both to convey and to provide the loading aids.

In this regard, it can also be provided for the proposed method that the loading aid in step v) and the loading aid loaded with an article in steps viii) and ix) are transported by the stationary conveying device of the first conveying system

It is advantageous for the first conveying system to comprise a buffer configured to buffer loading aids before they are transported to the loading device or the lifting device, wherein a plurality of buffer locations of the buffer arranged one behind the other can be arranged in particular along the first conveying section or along the second conveying section of the first conveying system. Fluctuations in the conveying flow can thereby be balanced out.

It is particularly advantageous for the first conveying system to comprise a sorting buffer configured to provide loading aids sorted in a sequence and having a plurality of buffer locations formed by the stationary conveying device along the first conveying section and a plurality of sorting locations formed by the stationary conveying device along the second conveying section, wherein the first conveying system has a plurality of sorting conveying devices connecting the sorting locations with the buffer locations. It is thereby possible to put the loading aids into a predeterminable sequence. In a further variation, it can be provided that the sorting buffer has at least one sorting location that can be reached on an alternative route, i.e. at least one sorting location that lies parallel to the first or second conveying section, in particular parallel to a buffer location on the first or second conveying section.

In this regard, it can also be provided for the proposed method that steps v) and/or ix) comprise a sorting of loading aids using the first conveying system, wherein a loading aid, in particular loaded with an article, can be transferred using a sorting conveying device from a sorting location configured on the stationary conveying device to a buffer location configured on the stationary conveying device.

Furthermore, it is favorable for the lifting device to comprise a lifting unit configured to transfer loading aids between the loading aid handover location and the first conveying system, wherein the lifting unit has a first transfer unit for transferring a loading aid between a transport vehicle provided at the loading aid handover location and the lifting unit as well as a second transfer unit for transferring a loading aid between the lifting unit and the stationary conveying system of the first conveying system. In this way, a loading aid can be transferred from a transport vehicle to the first conveying system. It is not necessary to lift the transport vehicle to do so.

In this regard, it can also be provided for the proposed method that
the loading aid in step iv) is handed over from the transport vehicle to the lifting device, is transferred upwards using the lifting device and handed over to a stationary conveying device of the first conveying system, and/or
the loading aid in step x) loaded with an article is handed over from the stationary conveying device of the first conveying system to the lifting device, is transferred downwards using the lifting device and handed over to a transport vehicle provided at the loading aid handover location.

In a further embodiment, it can also be provided that the loading aid handover location lies in the ground plane and the lifting device comprises a lifting unit configured to transfer loading aids together with transport vehicles between the loading aid handover location and the first conveying system, wherein the first conveying system comprises a second transfer unit for transferring loading aids between the stationary conveying device of the first conveying system and a transport vehicle provided by the lifting unit at the first conveying system. This way, a loading aid can similarly be transferred from a transport vehicle to the first conveying system; the transport vehicle is, however, lifted to the level of the first conveying system for this purpose.

In this regard, it can also be provided for the proposed method that
the loading aid together with the transport vehicle in step iv) is received from the lifting device and transferred upwards therewith, whereafter the loading aid is handed over from the transport vehicle to a stationary conveying device of the first conveying system, and/or
a transport vehicle is provided in step x) at the stationary conveying device of the first conveying system using the lifting device, whereafter the loading aid loaded with an article is handed over from the stationary conveying device of the first conveying system to the transport vehicle provided, whereafter the transport vehicle together with the loading aid loaded with an article is transferred downwards to the loading aid handover location using the lifting device.

Furthermore, it is particularly advantageous for the first conveying system to have a driving platform arranged above the cover plane, on which platform the transport vehicles are movable, wherein the driving platform extends from the first boundary plane to the second boundary plane, in particular from the lifting device to the loading device. A lower edge of the driving platform can, for example, thereby lie in the cover plane. Alternatively, it can be provided that the driving platform, in particular at least partially, is inclined upwards starting from the cover plane. The proposed measures allow the transport vehicles to drive up to the loading device and to transport the loading aid to there.

According to a further alternative embodiment, it can be provided that at least a section of the driving platform extends, inclined upwardly away from the ground plane towards a horizontal section of the driving platform, to the loading device or to the loading location, wherein in this case no (active) lifting device is required, or rather the lifting device is configured as a (passive) ramp. In this case, a sorting driving surface provided on the driving platform of the first conveying system can also be configured partially or fully on the ramp. In this regard, it should also be noted that it is possible that a shared first boundary plane and a shared second boundary plane do not necessarily have to be provided for the first conveying system and the second conveying system, but rather separate first boundary planes spaced apart from one another and/or separate second boundary planes spaced apart from one another can be provided for the first conveying system and the second conveying system. For example, the first boundary plane of the first conveying system can be arranged on the lower end of the ramp, whereas the first boundary plane of the second conveying system is arranged on the (active) lifting device. Alternatively, the first boundary plane of the first conveying system extends on the end of the ramp which adjoins the horizontal section of the driving platform. The first conveying system can thus also be arranged only partially above the driving zone. Furthermore, the vertical spacing between at least one section of the ground plane and the cover plane can correspond at least to a clearance height for transport vehicles each loaded with a loading aid.

Moreover, it is particularly advantageous for the loading aid provisioning device to have a provisioning driving platform adjoining the driving platform or arranged on the driving platform, the provisioning driving platform being, at least partially, inclined upwards or downwards in relation to the driving platform. This way, the loading aid can be provided in a particularly ergonomic manner.

It is also advantageous for the first conveying system to comprise a driving surface, preferably forming a closed circulation, arranged on the driving platform and drivable on by the transport vehicles. For example, the driving surface of the first conveying system can have a first driving surface section extending from the first to the second boundary plane, in particular from the lifting device to the loading device, and a second driving surface section extending from the second to the first boundary plane, in particular from the loading device to the lifting device. In a further embodiment, the driving surface of the first conveying system can have a third driving surface section connecting the first and second driving surface sections, forming the loading aid provisioning device and the loading location.

The proposed measures can again allow the transportation of a loading aid to and from the loading device in a simple manner, in particular where the driving surface has a closed circulation. In addition, a third conveying section has a double function, since it serves both to be driven on by the transport vehicle and to provide the loading aids.

In one embodiment variation, the loading aid provisioning device can comprise a stationary conveying device and a third transfer unit for transferring loading aids between transport vehicles on the driving surface of the first conveying system and the stationary conveying device of the loading aid provisioning device. The provision of the loading aids can thereby be performed by the stationary conveying device. The transport vehicles are thus not bound by the loading process and can also undertake other tasks in the meantime.

It is advantageous for the first conveying system to comprise a plurality of buffer locations arranged one behind the other, configured to buffer loading aids loaded on transport vehicles before they are transported to the loading device or the lifting device, wherein the buffers locations can be arranged in particular along the first driving surface section or along the second driving surface section of the first conveying system. Fluctuations in the conveying flow can thereby be balanced out. The buffer locations can also be understood as buffers.

Furthermore, it is particularly advantageous for the first conveying system to have at least one sorting driving surface arranged on the driving platform and diverging from the driving surface and merging into the drving surface elsewhere. It is thereby possible to put the loading aids into a predeterminable sequence.

In this regard, for the proposed method it can also be provided that steps v) and/or viii) comprise a sorting of loading aids by the first conveying system, wherein the transport vehicle together with the loading aid, in particular loaded with an article, moves onto a sorting driving surface diverging from the driving surface of the first conveying system and another transport vehicle together with the loading aid, in particular loaded with an article, moves on the driving surface of the first conveying system, such that the transport vehicle and the other transport vehicle are moved past one another, whereafter the transport vehicle moves from the sorting driving surface onto the driving surface of the first conveying system.

It is also particularly advantageous for an order to comprise a plurality of order lines and steps i) and ii) as well as vii) and viii) to be performed for an article of a first order line and be subsequently repeated for an article of a second order line, wherein the transport vehicle, after step vii) has been performed for the article of the first order line, moves onto a sorting driving surface diverging from the driving surface of the first conveying system and is buffered on the sorting driving surface until such a time as step i) is performed for the article of the second order line, and subsequently moves from the sorting driving surface onto the driving surface of the first conveying system and along the driving surface to the loading device, whereafter steps vii) and viii) are repeated for the article of the second order line. Analogously, the embodiment variation can also be provided if the first conveying system is configured as a stationary conveying device.

In a further embodiment variation, it can be provided that the lifting device has a lifting unit for transferring loading aids together with transport vehicles between the loading aid handover location and the driving platform. For example, the lifting unit can have a vertically movable lifting platform on which one of the transport vehicles together with loading aid can be positioned for transferring the loading aid. The proposed measures allow the transport vehicles to be transported back and forth between the driving plane and the driving platform.

The loading aid handover location preferably lies in or above the ground plane in the driving zone. A transport vehicle can be parked at the loading aid handover location. The lifting unit or lifting platform can preferably be aligned with the loading aid handover location, such that the parked transport vehicle can drive into the lifting unit and in particular can drive onto the lifting platform. Preferably, the loading aid handover location comprises a handover platform elevated from the ground plane and a ramp for the transport vehicles connecting the ground plane with the provisioning platform.

In regard to the above, for the proposed method it can also be provided that
the transportation of the loading aid in step v) and of the loading aid loaded with an article in steps viii) and ix) is performed using an autonomously movable, driverless transport vehicle and the transport vehicle
in step iv) together with the loading aid is transferred from the loading aid handover location of the first conveying system using the lifting device, whereafter the transport vehicle together with the loading aid moves from the lifting device onto the driving platform, and/or
in step x) together with the loading aid loaded with an article moves from the driving platform into the lifting device, whereafter the transport vehicle is transferred from the driving platform to the loading aid handover location using the lifting device.

Furthermore, for the proposed method it can also be provided that the transport vehicle in steps v), viii) and ix) moves on the driving platform on a driving surface, the driving surface extending from the lifting device to the loading device and from the loading device to the lifting device, in particular along a closed circulation.

In a further embodiment, it can be provided that the lifting unit has a ramp or climbing structure connecting the ground plane and the handover plane and/or the driving platform, along which ramp or climbing structure the transport vehicles are movable. In this case, no separate drive for lifting the transport vehicles is necessary, but rather the transport vehicles surmount the height difference themselves. Vertically movable transport vehicles are fundamentally known and are thus not described in detail.

Furthermore, it is conceivable for the lifting device to have two such lifting units, wherein one of the lifting units of the lifting device is provided for lifting loading aids from the loading aid handover location to the first conveying system and the other of the lifting units of the lifting device is provided for lowering loading aids from the first conveying system to the loading aid handover location A constant conveying flow can thereby be achieved, since lifting of a transport vehicle can occur independently from a lowering of another transport vehicle. In particular, the transport vehicles can be moved according to the one-way system in the region of the loading station.

Moreover, it is favorable for the lifting system to have a further lifting device for transferring an article (with or without loading aid) between an article handover location arranged below the cover plane and the second conveying system, wherein the second conveying system connects the further lifting device with the loading device. It is thereby possible for articles to be able to surmount a height difference to the second conveying system.

It is preferably provided that the further lifting device, analogously to the previously described lifting device for transferring loading aids, is aligned with a side of the first boundary plane facing away from the driving zone. Optionally, the further lifting device can also protrude into the driving zone or alternatively be arranged in the driving zone.

It is advantageous for the second conveying system to comprise a stationary conveying system, preferably forming a closed circulation, for transporting articles (with or without loading aid) between the first and second boundary planes, in particular between the further lifting device and the loading device. For example, the stationary conveying device of the second conveying system can have a first conveying section extending from the first to the second boundary plane and/or from the further lifting device to the loading device, and a second conveying section extending from the second to the first boundary plane and/or from the loading device to the further lifting device. In a further embodiment, the stationary conveying device of the second conveying system can have a third conveying section connecting the first and second conveying sections, forming the article provisioning device and the removal location.

The proposed measures allow for an article to be transported in a simple manner to and from the loading device, in particular where the stationary conveying device has a closed circulation. In addition, a third conveying section has a double function, since it serves both to convey and to provide the articles.

If, for example, no further lifting device is provided for the second conveying system, the stationary conveying device can, for instance, adjoin a stationary conveying device of the storage system extending from an article storage of a storage system to the loading station for the transportation of articles (with or without loading aid).

Generally, the stationary conveying device of the second conveying system (and/or of the first conveying system) can have a support frame, one or more conveyor elements mounted on the support frame, and one or more drive elements for the conveyor elements mounted on the support frame. The drive elements are preferably configured as motorized conveyor rollers. The conveyor elements can, for example, comprise conveyor rollers and/or a conveyor belt stretched around the drive elements.

It is advantageous for the second conveying system to comprise a buffer configured to buffer articles (with or without loading aid) before they are transported to the loading device or the further lifting device, wherein a plurality of buffer locations of the buffer arranged one behind the other can be arranged in particular along the first conveying section or along the second conveying section of the second conveying system. Fluctuations in the conveying flow can thereby be balanced out.

It is particularly advantageous for the second conveying system to comprise a sorting buffer configured to provide articles (with or without loading aid) sorted in a sequence and having a plurality of buffer locations formed by the stationary conveying device along the first conveying section and a plurality of sorting locations formed by the stationary conveying device along the second conveying section, wherein the second conveying system has a plurality of sorting conveying devices connecting the sorting locations with the buffer locations. It is thereby possible to put the articles into a predeterminable sequence. In a further variation, it can be provided that the sorting buffer has at least one sorting location that can be reached on an alternative route, i.e. at least one sorting location that lies parallel to the first or second conveying section, in particular parallel to a buffer location on the first or second conveying section.

It is favorable for the further lifting device to comprise a lifting unit for transferring an article between an article handover location arranged below the cover plane and the second conveying system, wherein the lifting unit has a first transfer unit for transferring an article between the lifting unit and a transport vehicle provided at the article handover location as well as a second transfer unit for transferring an article between the lifting unit and the stationary conveying system of the second conveying system. In this way, an article can be transferred from a transport vehicle to the second conveying system. It is not necessary to lift the transport vehicle to do so.

In a further embodiment, it can also be provided that the further lifting device comprises a lifting unit configured to transfer articles together with transport vehicles between the article handover location and the second conveying system, wherein the second conveying system comprises a second transfer unit for transferring articles between the stationary conveying device of the second conveying system and a transport vehicle provided by the lifting unit at the second conveying system. This way, an article can similarly be transferred from a transport vehicle to the second conveying system; the transport vehicle is, however, lifted to the level of the second conveying system for this purpose.

Moreover, it is particularly advantageous for the further lifting device to have two such lifting units, wherein one of the lifting units of the further lifting device is provided for lifting articles from the article handover location to the second conveying system and the other of the lifting units of the further lifting device is provided for lowering articles from the second conveying system to the article handover location. Again, a constant conveying flow can thereby be achieved, since lifting of an article can occur independently from a lowering of another article. In particular, the articles can be moved according to the one-way system in the region of the loading station.

Generally, the loading station can have a plurality of autonomously movable, driverless transport vehicles for transporting loading aids and for moving in the driving zone in the ground plane. In particular, as already mentioned, the transport vehicles can be movable alternately and/or selectively in the ground plane or the driving platform. The transport vehicles can each have a chassis with a drive unit and a loading platform arranged on the chassis for receiving a loading aid.

It is particularly advantageous for the loading platform to be movable between a transport position and a provisioning position in order to provide loading aids at the loading device at an ergonomic height for loading. It is thereby favorable for the loading aids to be provided by the loading platform in the provisioning position at the aforementioned (ergonomic) provisioning height when the transport vehicle is at the loading location.

Generally, the loading station can comprise a first support structure on which the first conveying system is mounted, in particular the described stationary conveying device or driving platform of the first conveying system. Alternatively or in addition, the loading station can comprise a second support structure on which the second conveying system is mounted, in particular the described stationary conveying device of the second conveying system.

Using the first support structure, the first conveying system can, for example, be suspended from a ceiling of a storage system or positioned in the ground plane, for instance on a floor (of a story) of the storage system. Preferably, the stationary conveying device of the first conveying system, in particular the previously described support frame, or the driving platform of the first conveying system can be mounted on the first support structure. The first support structure preferably comprises a plurality of vertical uprights.

Furthermore, using the second support structure the second conveying system can, for example, be suspended from the ceiling of the storage system or positioned in the ground plane, for instance on a floor (of a story) of the storage system. Optionally, the second support structure can be installed on the driving platform of the first conveying system, such that the second conveying system stands on the driving platform. Preferably, the stationary conveying device of the second conveying system, in particular the previously described support frame, is mounted on the second support structure. The second support structure preferably also comprises a plurality of vertical uprights.

In a further embodiment variation of the loading station, it can also be provided that
the driving surface of the driving zone and
optionally the further driving surface of the driving zone, the provisioning driving surface, the driving surface of the first conveying system and/or the sorting driving surface are each marked with optical driving path markers which are detectable and followable by the transport vehicles.

This way, the transport vehicles can be guided along predetermined paths in a simple way. The driving paths can also be particularly flexibly adjusted to changing circumstances by rearranging the optical markers.

Furthermore, it is favorable for a horizontal spacing between the first and second boundary planes to correspond at least to a width of two transport vehicles arranged one next to the other. Two transport vehicles can thereby pass one another.

According to an advantageous embodiment variation of the storage system, the storage and retrieval conveying system can have a storage driving zone and autonomously movable, driverless transport vehicles in the storage driving zone, wherein the storage driving zone extends from the storage zone to the lifting system of the loading station, in particular to the article handover location. The articles can thus be transported using driverless transport vehicles from the storage zone to the lifting system, in particular to the further lifting device, of the loading station.

It is favorable for the storage system to have
an order post-processing zone with at least one working location for performing post-processing orders, in particular manually
a transfer driving zone extending from the driving zone of the at least one loading station to the order post-processing zone, and
a plurality of autonomously movable, driverless transport vehicles in the driving zone of the at least one loading station and in the transfer driving zone in order to transport loading aids.

Processes other than loading of the loading aid can thus be performed in the storage system.

Post-processing orders can each be electronically acquired as a dataset and be processed, for example, by a warehouse management system. Post-processing orders are, as a rule, not picking orders. Thus, a post-processing order can follow a picking order as soon as one or more order lines of that picking order have been picked. A picking order comprises one or more order lines, wherein each order line denotes one (ordered) article by its article type and its (ordered) number of pieces. The post-processing orders comprise in particular one or more value added services, such as packaging, disposal, labelling, quality control of the article, an addition of a package insert or an invoice for the article and the like. The at least one working location of the post-processing zone can be configured so that various post-processing orders can be performed. For example, the post-processing orders “package a picked article” and “include a brochure” can be performed at one working location. A post-processing order can also comprise the offloading of the loading aid onto a truck that subsequently exits the storage system with the article. The processing order can also only comprise the offloading. The order post-processing zone can then also be understood as an offloading zone.

As already mentioned, the storage system can have a plurality of loading stations arranged one next to the other, wherein the driving zones of the loading stations are connected with one another. A modular storage system construction is thereby possible.

Generally, with the proposed method it is advantageous for step iii) to be performed for a further loading aid, while step v) for the loading aid and/or one or more of steps viii) and ix) for the loading aid loaded with an article are performed, wherein the further loading aid is moved underneath the driving surface of the first conveying system, in particular underneath the loading aid. The loading station can thereby be operated in a particularly efficient manner.

In a variation of the proposed method, it can also be provided that in step i) an article is transported using an autonomously movable, driverless transport vehicle (in particular a storage and retrieval conveying system of a storage system of the disclosed type) in a storage driving zone, preferably on a storage driving surface, to the loading station and is handed over to the loading station, in particular to the second conveying system of the loading station. It can thereby be provided that the transport vehicles of the storage and retrieval conveying system are moved by the lifting system, in particular by the further lifting device, to the second conveying system, whereafter the article is handed over to the second conveying system. Alternatively, it can be provided that the article is transported to the article handover location by the transport vehicles and handed over to the further lifting device. The article can thereby be moved by the further lifting device to the second conveying system and be handed over to it.

In a variation of the disclosed method, the loading aid provided in step vii) can be loaded with articles of a plurality of (different) orders. Articles of a plurality of orders can thereby be transported away from the loading station in a single step and, for example, be taken to an order post-processing zone.

It is also conceivable that steps iii) to vii) are repeated for a plurality of loading aids by one transport vehicle each and that step vii) is repeated for articles of one article type provided in step i) for a plurality of orders for the loading aids provided one after the other. The loading of a plurality of loading aids can thereby be performed particularly efficiently, since in step i) articles of one (in particular a single) article type are provided for a plurality of loading aids.

Finally, it is particularly advantageous for the second conveying system to comprise a plurality of buffer locations and for step i) to be repeated for articles of a different article type, wherein the article is buffered at the buffer locations. It is thereby possible to load loading aids with articles of a different article type without the articles having to be provided from the store each time. Rather, they are intermediately buffered in the second conveying system as required.

It should be noted here that the embodiment variations disclosed regarding the loading station and the storage system and the resulting advantages also relate analogously to the proposed method for loading loading aids and vice versa.

For a better understanding of the invention, it is explained in more detail with reference to the following figures.

They show in significantly simplified, schematic representation:

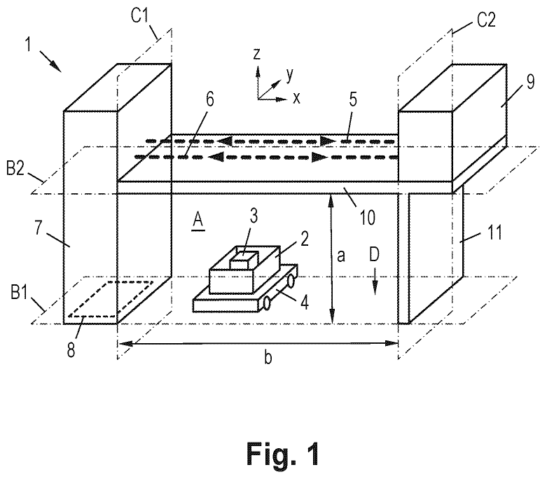

FIG. 1 an oblique schematic view of an example loading station;

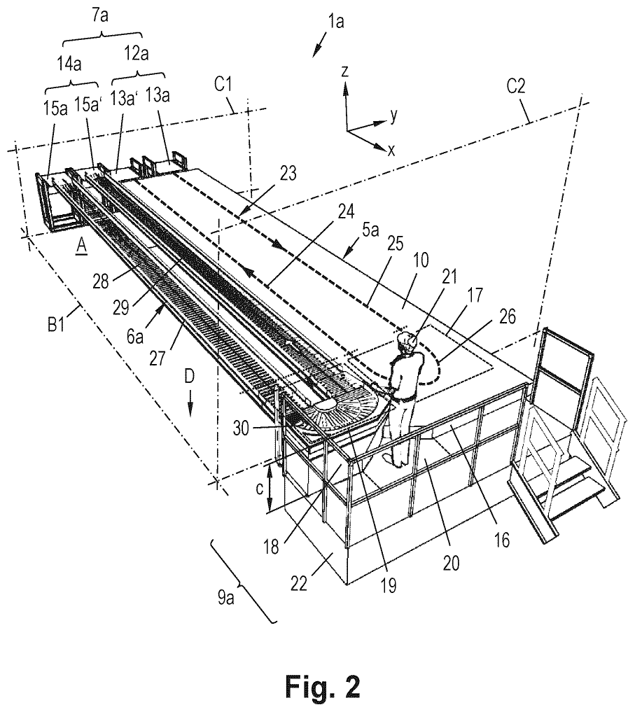

FIG. 2 an oblique detailed view of an embodiment of a loading station;

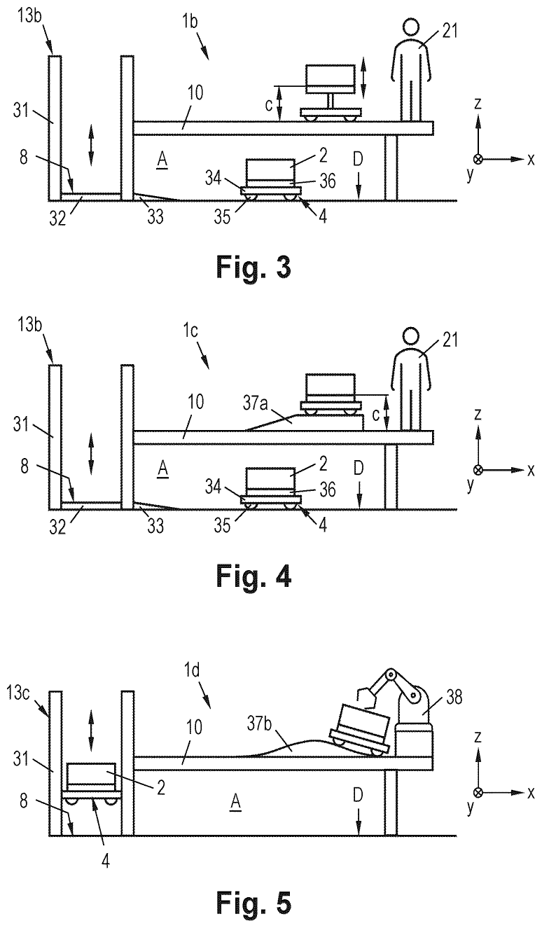

FIG. 3 a schematic side view of a loading station with a transport vehicle with a height-adjustable loading platform;

FIG. 4 a schematic side view of a loading station with a provisioning driving platform;

FIG. 5 a schematic side view of a loading station with a climbing structure for the transport vehicles and a loading robot;

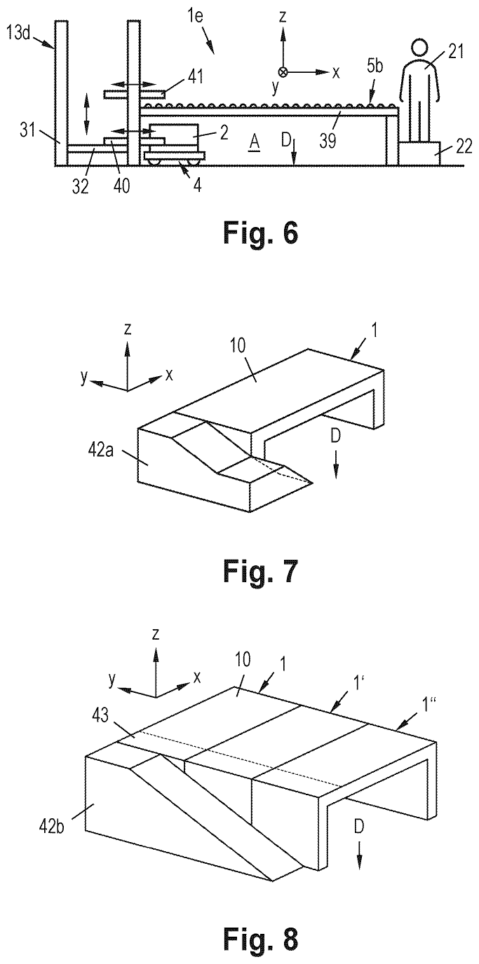

FIG. 6 an example of a loading station in which the first conveying system is configured as a stationary conveying device;

FIG. 7 an embodiment variation in which the lifting unit has a ramp for the transport vehicles;

FIG. 8 a further example embodiment with a ramp, which, however, extends across a plurality of loading station;

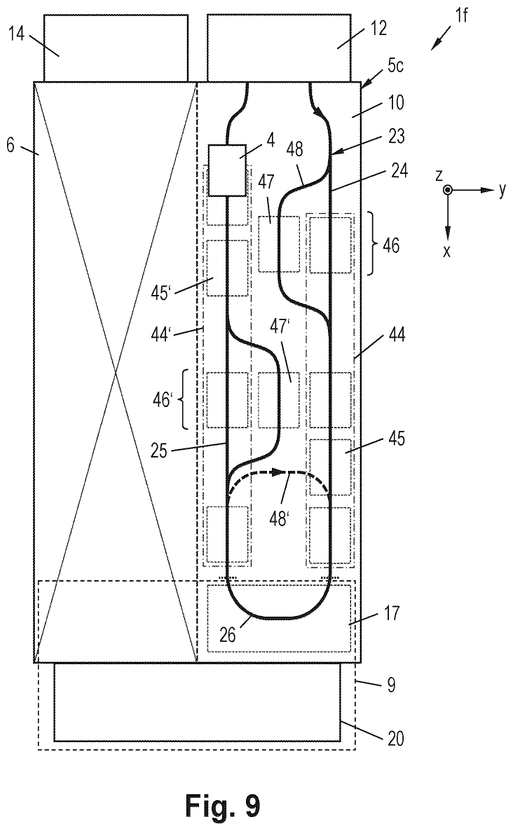

FIG. 9 a top view of an example of a loading station with buffers and sorting buffers;

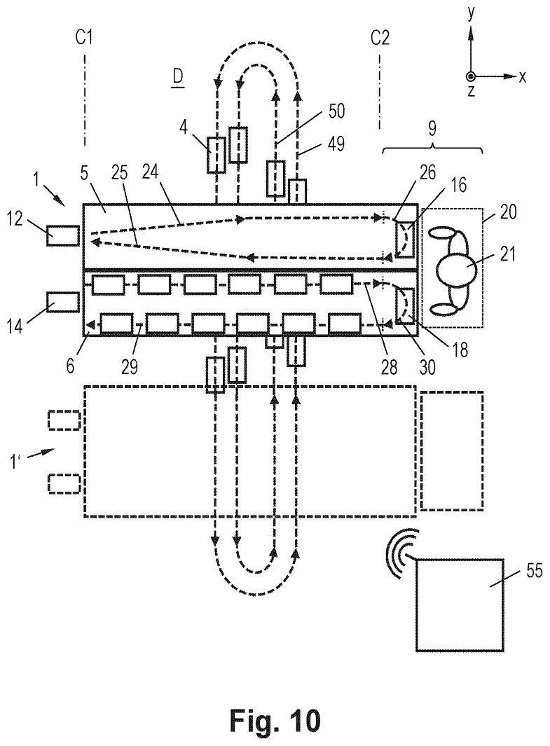

FIG. 10 a top view of a schematic representation of an assembly of loading stations including the driving area below;

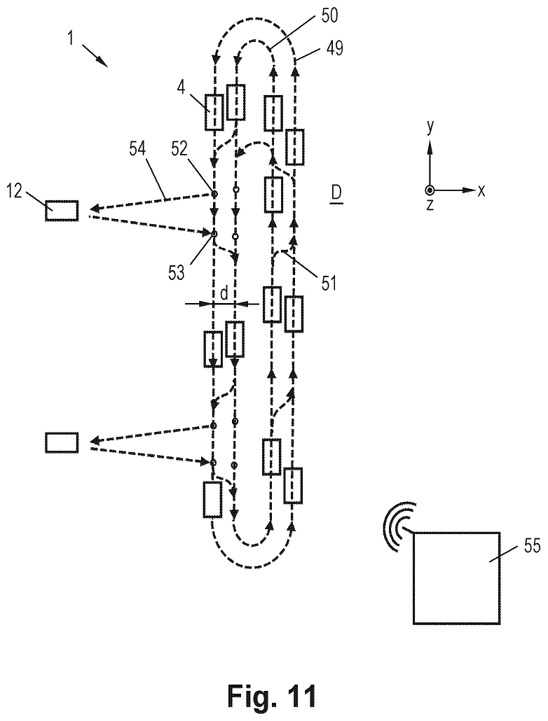

FIG. 11 similar to FIG. 10, however with loading stations omitted;

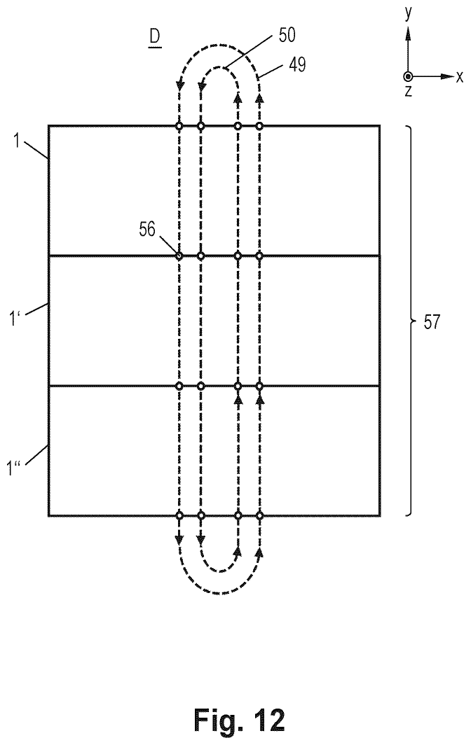

FIG. 12 a top view of a loading station group;

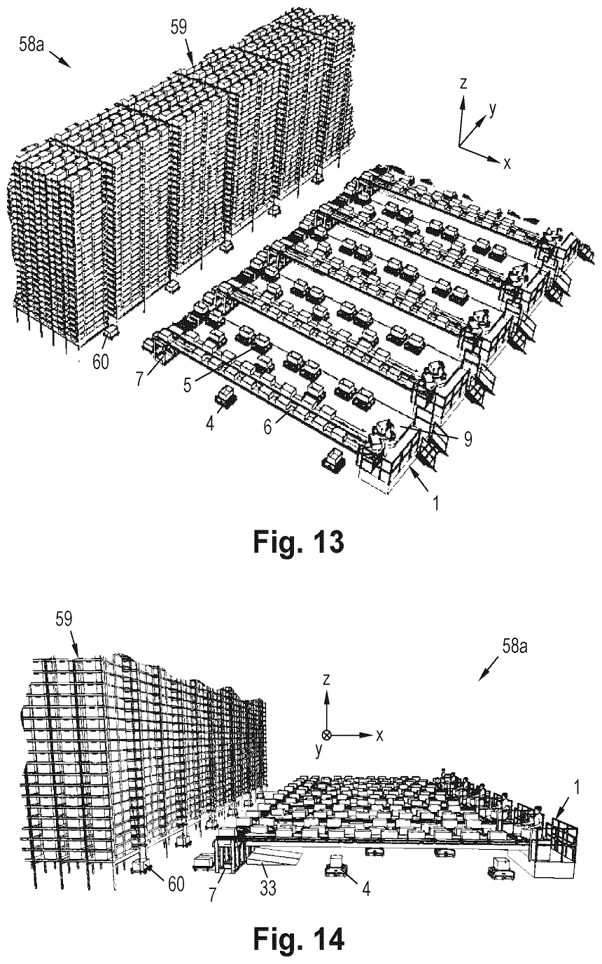

FIG. 13 a detailed oblique perspective view of an example of a storage system;

FIG. 14 the storage system of FIG. 13 seen from the side and above;

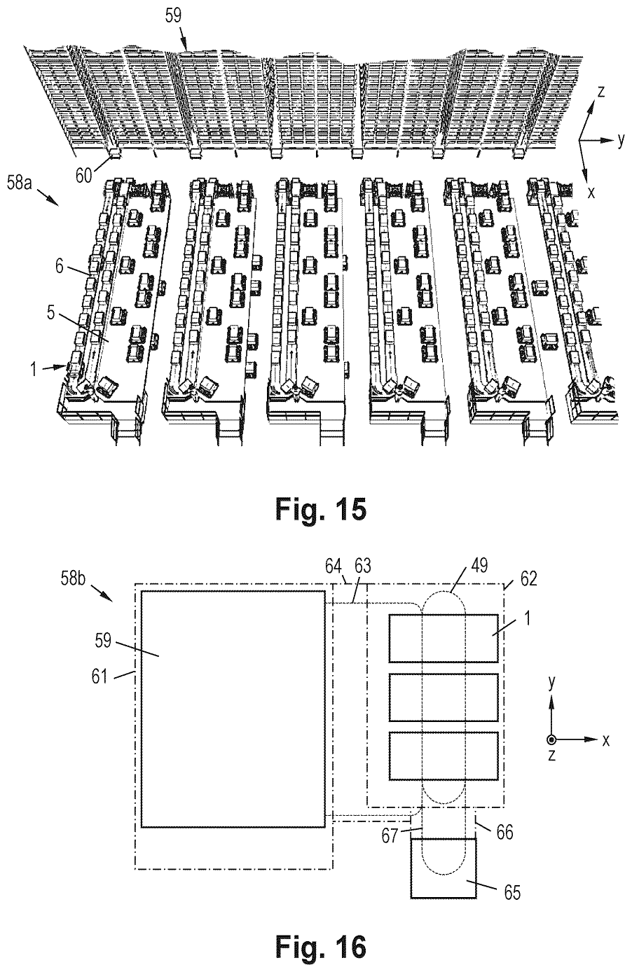

FIG. 15 the storage system of FIG. 13 seen from the front and above, and

FIG. 16 a top view of a schematic representation of a storage system with an order processing zone.

It is worth noting here that the same parts have been given the same reference numerals or same component designations in the embodiments described differently, yet the disclosure contained throughout the entire description can be applied analogously to the same parts with the same reference numerals or the same component designations. The indications of position selected in the description, such as above, below, on the side etc. refer to the figure directly described and shown, and can be applied in the same way to the new position should the position change.

FIG. 1 shows a schematic oblique view of an example loading station 1 for loading loading aids 2 with articles 3. The loading station 1 comprises a driving zone A in which autonomously movable, driverless transport vehicles 4 for transporting the loading aids 2 are movable, a ground plane B1 and a cover plane B2 opposite the ground plane B1 at a vertical spacing a, and a first boundary plane C1 and a second boundary plane C2 opposite the first boundary plane C1 at a horizontal spacing b, each intersecting the ground plane B1 and the cover plane B2, preferably at a right angle, as is the case in FIG. 1. The ground plane B1 and the cover plane B2 delimit the driving zone A in a vertical direction z, the first boundary plane C1 and the second boundary plane C2 in a horizontal (longitudinal) direction x. The driving zone A has a driving area D arranged in the ground plane B1 in which the transport vehicles 4 are movable.

The ground plane B1 and the cover plane B2 can be inclined in relation to one another or be aligned parallel to one another. It is particularly preferable for the ground plane B1 and the cover plane B2 to each be aligned horizontally. Analogously, the first and second boundary planes C1, C2 can be inclined in relation to one another or be aligned parallel to one another. Preferably, the first and second boundary planes C1, C2 are each aligned vertically. The driving zone A is thus preferably quadrilateral in vertical section, in particular trapezoidal, parallelogram-shaped, rectangular, or square.

It is favorable for the loading station 1 to further have a third boundary plane and a fourth boundary plane (not shown) opposite the third boundary plane at a horizontal spacing, each intersecting the ground plane B1, the cover plane B2 and the first and second boundary planes C1, C2, preferably at a right angle, and delimiting the driving zone A in a further horizontal (transverse) direction y. According to a particularly preferred embodiment, the third and fourth boundary planes are aligned vertically. The driving zone A can thus have a parallelepiped shape, in particular a cuboid or cube.

Furthermore, the loading station 1 comprises a first conveying system 5 for transporting loading aids 2 and a second conveying system 6 for transporting articles 3 (with or without loading aids 2).

In addition, the loading station 1 comprises a lifting system 7 with a lifting device 12, 12a aligned with a side of the first boundary plane C1 facing away from the driving zone A for transferring loading aids 2 (with or without transport vehicle 4) between a loading aid handover location 8 arranged on the lifting device 7 below the cover plane B2, in particular in the driving zone A, for example on the lifting device 12, 12a, and the first conveying system 5.

Furthermore, the loading station 1 comprises a loading device 9 aligned with a side of the second boundary plane C2 facing away from the driving zone A for loading loading aids 2 with articles 3 provided at the loading device 9.

The first conveying system 5 and the second conveying system 6 are arranged above the driving zone A and each extend from the first boundary plane C1 to the second boundary plane C2, wherein the first conveying system 5 connects the lifting system 7, in particular the lifting device 12, 12a, with the loading device 9. The vertical spacing a between the ground plane B1 and the cover plane B2 corresponds at least to a clearance height for a transport vehicle 4 loaded with a loading aid 2. The area below the first conveying system 5 and the second conveying system 6 is thereby made usable for transport vehicles 4.

Preferably, a horizontal spacing b between the first and second boundary planes C1, C2 also corresponds at least to a width of two transport vehicles 4 arranged one next to the other. This way, transport vehicles 4 can pass one another in the driving zone A.

In this example, the first conveying system 5 and the second conveying system 6 are arranged on a support structure configured as a platform 10 and on a support structure configured as an upright 11. Fundamentally, the first conveying system 5 and the second conveying system 6 could, however, also be self-supporting.

Generally, the loading station 1 can thus comprise a first support structure on which the first conveying system 5 is mounted and/or a second support structure on which the second conveying system 6 is mounted. The first and/or second support structure preferably comprise a plurality of vertical uprights.

Using the first support structure, the first conveying system 5 can, for example, be suspended from a ceiling of a storage system or positioned in the ground plane B1, for instance on a floor (of a story) of the storage system. Preferably, the first conveying system 5, in particular the driving platform 10 of the first conveying system 5, is mounted on the first support structure.

Likewise, using the second support structure the second conveying system 6 can, for example, be suspended from the ceiling of the storage system or positioned in the ground plane B1, for instance on a floor (of a story) of the storage system. Optionally, the second support structure can be installed on the driving platform 10 of the first conveying system 5, such that the second conveying system 6 stands on the driving platform 10. Preferably, a stationary conveying device of the second conveying system 6, in particular a support frame of the second conveying system 6, is mounted on the second support structure.

FIG. 2 shows a somewhat more detailed oblique view of an embodiment of a loading station 1a. In this example, the lifting system 7a comprises a lifting device 12a for the first conveying system 5a, itself having two lifting units 13a, 13a′. Analogously, in this example the lifting system 7a has a further lifting device 14a for the second conveying system 6a, which has two lifting units 15a, 15a′.

In this example, the loading device 9a has a loading aid provisioning device 16 for providing loading aids 2 at a loading location 17 and an article provisioning device 18 for providing articles 3 (with or without loading aids 2) at a removal location 19. The loading aid provisioning device 16 and the article provisioning device 18 are configured to provide loading aids 2 and articles 3 at a provisioning height c, in particular an ergonomic one for manually loading the loading aids 2. For this purpose, the loading location 17 and/or the removal location 19 can be arranged at the (respective) provisioning height c.

The loading station 1a additionally has a working location 20 for manually loading loading aids 2 provided at the loading location 17 with articles 3 provided at the removal location 19. In FIG. 2, a worker 21 is standing at a working location 20 which in this example is arranged on a pedestal 22.

In this example, the first conveying system 5a comprises transport vehicles 4 for moving on the platform 10 (not shown in FIG. 2; can, however, be seen in the following figures). The platform 10, in this example a part of the first conveying system 5a, is thus configured as a driving platform. The driving platform 10 is arranged above the cover plane B2 and extends from the first boundary plane C1 to the second boundary plane C2, specifically from the lifting device 12a to the loading device 9a. A lower edge of the driving platform 10 can, for example, thereby lie in the cover plane B2. Alternatively, it can be provided that the driving platform 10 is inclined upwards starting from the cover plane B2.

According to a further alternative embodiment, it can be provided that at least a section of the driving platform 10 extends, inclined upwardly away from the ground plane B1 towards a horizontal section of the driving platform 10, to the loading device 9a or to the loading location 17, wherein in this case no (active) lifting device 12a is required, or rather the lifting device 12a is configured as a (passive) ramp. In this case, a sorting driving surface 48, 48′ provided on the driving platform 10 of the first conveying system 5a can also be configured partially or fully on the ramp (also see FIG. 9). In this regard, it should also be noted that it is possible that a shared first boundary plane C1 and a shared second boundary plane C2 do not necessarily have to be provided for the first conveying system 5a and the second conveying system 6a, but rather separate first boundary planes C1 spaced apart from one another and/or separate second boundary planes C2 spaced apart from one another can be provided for the first conveying system 5a and the second conveying system 6a. For example, the first boundary plane C1 of the first conveying system 5a can be arranged on the lower end of the ramp, whereas the first boundary plane C1 of the second conveying system 6a is arranged on the (active) lifting device 14a. Alternatively, the first boundary plane C1 of the first conveying system 5a can extend on the end of the ramp adjoining the horizontal section of the driving platform 10. The first conveying system 5a can thus also be arranged only partially above the driving zone 10. Furthermore, the vertical spacing a between at least one section of the ground plane B1 and the cover plane B2 can correspond at least to a clearance height for transport vehicles 4 each loaded with a loading aid 2.

The first conveying system 5a can comprise a driving surface 23 arranged on the driving platform 10 and drivable on by transport vehicles 4, preferably forming a closed circulation, as is the case in FIG. 2. Specifically, in the example shown, the driving surface 23 of the first conveying system 5a has a first driving surface section 24 extending from the first boundary plane C1 to the second boundary plane C2 and in particular from the lifting device 12a to the loading device 9a, and a second driving surface section 25 extending from the second boundary plane C2 to the first boundary plane C1 and in particular from the loading device 9a to the lifting device 12a. In addition, the driving surface 23 of the first conveying system 5a has a third driving surface section 26 connecting the first and second driving surface sections 24, 25, forming the loading aid provisioning device 16 and the loading location 17 in this example.

The second conveying system 6a has a similar structure to the first conveying system 5a, although it is based on a stationary conveying device for transporting articles 3. Specifically, the second conveying system 6a comprises a stationary conveying device 27, preferably forming a closed circulation, for transporting articles 3 (with or without loading aid 2) between the first boundary plane C1 and the second boundary plane C2, in particular between the further lifting device 14a for the second conveying system 6a and the loading device 9a.

Specifically, in the example shown, the stationary conveying device 27 of the second conveying system 6a has a first driving surface section 28 extending from the first boundary plane C1 to the second boundary plane C2 and in particular from the further lifting device 14a to the loading device 9a, and a second driving surface section 29 extending from the second boundary plane C2 to the first boundary plane C1 and in particular from the loading device 9a to the further lifting device 14a. In addition, the stationary conveying device 27 of the second conveying system 6a has a third driving surface section 30 connecting the first and second driving surface sections 28, 29, forming the article provisioning device 18 and the removal location 19 in this example.

The stationary conveying device 27 of the second conveying system 6a can have a support frame, one or more conveyor elements mounted on the support frame, and one or more drive elements for the conveyor elements mounted on the support frame. The drive elements are preferably configured as motorized conveyor rollers. The conveyor elements can, for example, comprise conveyor rollers and/or a conveyor belt stretched around the drive elements. In FIG. 2, the conveyor elements are conveyor rollers, of which at least some are driven.

The lifting units 13a, 13a′ of the lifting device 12a for the first conveying system 5a are configured to transfer loading aids 2 together with transport vehicles 4 between the loading aid handover location 8 and the driving platform 10. The lifting units 13a, 13a′ each comprise a vertically movable lifting platform on which one of the transport vehicles 4 together with loading aid 2 can be positioned in order to transfer the loading aid 2.

Preferably, the lifting device 12a for the first conveying system 5a can be configured such that one of the lifting units 13a of the lifting device 12a is provided for lifting loading aids 2 from the loading aid handover location 8 to the first conveying system 5a and the other of the lifting units 13a′ of the lifting device 12a is provided for lowering loading aids 2 from the first conveying system 5a to the loading aid handover location 8, as is the case in FIG. 2. This way, the loading aids 2 can be moved according to the one-way system in the area of the loading station 1a.

FIG. 3 shows a schematic side view of a further example of a loading station 1b. In this example, the lifting unit 13b of the first conveying system 5, 5a specifically comprises two uprights 31 and a lifting platform 32 vertically movable between them.

The loading aid handover location 8 preferably lies in or borders the driving zone A on or above the ground plane B1. A transport vehicle 4 can be positioned at the loading aid handover location 8. The lifting unit 13b, specifically the lifting platform 32, can preferably be aligned with the loading aid handover location 8 such that the parked transport vehicle 4 can enter the lifting unit 13b, or more precisely, can drive onto the lifting platform 32. Subsequently, the transport vehicle 4 can be lifted to the level of the driving platform 10. The loading aid handover location 8 preferably comprises a handover platform elevated from the ground plane B1. More preferably, the loading station 1b comprises a ramp 33 for the transport vehicles 4 connecting the ground plane B1 with the handover platform or the lifting platform 32.

The transport vehicles 4 each have a chassis 34 with wheels 35 mounted thereon and a drive unit not shown here. Furthermore, the transport vehicles 4 have a loading platform 36 arranged on the chassis 34 for receiving a loading aid 2. In this example, the loading platform 36 can be moved between a transport position (see lower transport vehicle 4) and a provisioning position (see upper transport vehicle 4) in order to provide loading aids 2 at the loading device 9, 9a at an ergonomic height for loading. It is thereby favorable for the loading aids 2 to be provided by the loading platform 36 in the provisioning position at the aforementioned (ergonomic) provisioning height c when the transport vehicle 4 is at the loading location 17.

Generally, a plurality of autonomously movable, driverless transport vehicles 4 for transporting loading aids 2 can be provided for moving in the driving zone A in the ground plane B1. The transport vehicles 4 can also be alternately and/or selectively movable in the ground plane C1 or the driving platform 10, as is the case in the example shown in FIG. 3.

FIG. 4 shows an example of a loading station 1c which is very similar to the loading station 1b shown in FIG. 3. Unlike that example, the loading aid provisioning device 16 in this example comprises a provisioning driving platform 37a adjoining the driving platform 10 or arranged on the driving platform 10, the provisioning driving platform 37a being partially inclined in relation to the driving platform 10. That is to say, the provisioning driving platform 37a also comprises a ramp. Using the provisioning driving platform 37a, the loading aids 2 can be provided at the provisioning height c even if the loading platform 36 is not vertically adjustable.

FIG. 5 shows an example of a loading station 1d which is similar to the loading station 1c shown in FIG. 4. Unlike that loading station, the provisioning driving platform 37b here is inclined towards the working location 20. The loading aid 2 is thereby particularly easy to access. Alternatively or in addition to the inclined loading location 17, the removal location 19 can also be arranged with an inclination towards the working location 20 in order to enable ergonomic access to the provided article 3.

A further difference from the loading station 1c is that the loading station 1d has a loading robot 38 for automated loading of loading aids 2 provided at the loading location 17 with articles 3 provided at the removal location 19. It is particularly preferable for the loading station 1d to comprise both a working location 20 for manual loading and a loading robot 38, wherein loading of the loading aid 2 can be performed selectively by the loading robot 38 or a picker 21. Optionally, the loading robot 38 can also be provided as a collaborative robot (cobot) and be configured to work together with humans. In this case, loading can be performed substantially simultaneously by the loading robot 38 and a picker 21.

Yet another difference is that the loading station 1d does not have a vertically movable loading platform 36, rather the uprights 31 form a climbing structure on which the transport vehicles 4 can autonomously move vertically.

FIG. 6 shows an example of a loading station 1e in which the first conveying system 5b is configured as a stationary conveying device 39. Specifically, the stationary conveying device 39 of the first conveying system 5b can have a support frame, one or more conveyor elements mounted on the support frame, and one or more drive elements for the conveyor elements mounted on the support frame. The drive elements are preferably provided as motorized conveyor rollers. The conveyor elements can, for example, comprise conveyor rollers and/or a conveyor belt stretched around the drive elements. In FIG. 6, the conveyor elements are conveyor rollers, of which at least some are driven.

The first conveying system 5b can have a similar structure to the first conveying system 5a shown in FIG. 2. Specifically, the first conveying system 5b can comprise a stationary conveying device 39, preferably forming a closed circulation, for transporting loading aids 2 between the first boundary plane C1 and the second boundary plane C2 and in particular between the lifting device 12, 12a and the loading device 9, 9a. For example, the stationary conveying device 39 of the first conveying system 5b can have a first conveying section extending from the first boundary plane C1 to the second boundary plane C2 and in particular from the lifting device 12, 12a to the loading device 9, 9a, and a second conveying section extending from the second boundary plane C2 to the first boundary plane C1 and in particular from the loading device 9, 9a to the lifting device 12, 12a, as is realized in FIG. 2 with the conveying sections 24 and 25. Furthermore, the stationary conveying device 39 of the first conveying system 5b can also have a third conveying section connecting the first and second conveying sections, forming the loading aid provisioning device 16 and the loading location 17, as is realized in FIG. 2 with conveying section 26.

The second conveying system 6a shown in FIG. 2, which also has a stationary configuration and comprises conveying sections 28, 29 and 30, constitutes another analogy for the first conveying system 5b. That is to say, the first conveying system 5b can have a similar or even identical structure to the second conveying system 6, 6a.

The lifting device 12, 12a again comprises a lifting unit 13d configured to transfer loading aids 2 between the loading aid handover location 8 and the first conveying system 5b. In this case, however, the lifting unit 13d has a first transfer unit 40 for transferring a loading aid 2 between a transport vehicle 4 provided at the loading aid handover location 8 and the lifting unit 13d, and a second transfer unit 41 for transferring a loading aid 2 between the lifting unit 13d and the stationary conveying system of the first conveying system 5b. For example, the transfer units 40, 41 can each comprise telescopic arms with grippers to be able to move the loading aid 2 horizontally.

FIG. 7 shows an embodiment variation in which the lifting unit is configured differently. Specifically, it has a ramp 42a connecting the ground plane B1 and the driving platform 10 along which transport vehicles 4 are movable. That means that the transport vehicles 4 can independently surmount a height difference in this embodiment variation as well. In this case, the ramp 42a extends around the corner and traverses the first boundary plane C1, protruding somewhat into the driving zone A. Fundamentally, a ramp 42a is not bound by the specific shape shown in FIG. 7, but rather could also have a different shape.

FIG. 8 shows a further example embodiment with a ramp 42b, which in this example, however, is guided by a plurality of loading stations 1 . . . 1″ in order to bridge a comparatively large height difference at a moderate gradient. The height difference is thus more easily surmountable for the transport vehicles 4. A shared driving zone 43 is also provided on the loading stations 1 . . . 1″ so that the transport vehicles 4 can reach all loading stations 1 . . . 1″.

It should be noted here that the individual features disclosed in FIG. 2 to 8 can be combined in any way. For instance, in all examples a robot 38 can be used or the first conveying system 5b can be configured as a stationary conveying device 39. The use of transport vehicles 4 with a vertically adjustable lifting platform 32 is also generally possible.

A mixture of the lifting units 13b, 13c shown in FIGS. 3 and 6 is also conceivable. For example, the lifting unit 13d can be configured to transfer loading aids 2 together with transport vehicles 4 between the loading aid handover location 8 and the first conveying system 5b, wherein the first conveying system 5b comprises a transfer unit for transferring loading aids 2 between the stationary conveying device of the first conveying system 5b and a transport vehicle 4 provided by the lifting unit 13d at the first conveying system 5b (also see the second transfer unit 41 in FIG. 6). For this purpose, the transfer unit can be configured like the first transfer unit 40 or the second transfer unit 41.

Analogously, it is generally also conceivable for the loading aid provisioning device 16 to comprise a stationary conveying device 39 and a third transfer unit for transferring loading aids 2 between transport vehicles 4 on the driving surface 23 of the first conveying system 5, 5a and the stationary conveying device of the loading aid provisioning device 16. For this purpose, the third transfer unit can be configured like the first transfer unit 40 or the second transfer unit 41. For example, the stationary conveying device of the loading aid provisioning device 16 can be substantially constructed in the same way as the third conveying section 30 of the second conveying system 6a from FIG. 2.

The further lifting device 14a can generally be constructed in the same or a similar way as the lifting device 12a for the first conveying system 5, 5b.

Preferably, the further lifting device 14a is aligned with the side of the first boundary plane C1 facing away from the driving zone A and is configured to transfer an article 3 (with or without loading aid 2) between an article handover location arranged below the cover plane B2 and the second conveying system 6, 6a, wherein the second conveying system 6, 6a connects the further lifting device 14a with the loading device 9, 9a. The article handover location can thereby have the same or a similar construction as the loading aid handover location 8.

For example, the further lifting device 14a can have lifting units 15a, 15a′ for transferring articles 3 between an article handover location arranged below the cover plane B2 and the second conveying system 6, 6a, wherein the lifting units 15a, 15a′ each have a first transfer unit for transferring articles 3 between the lifting units 15a, 15a′ and a transport vehicle 4 provided at the article handover location as well as a second transfer unit for transferring articles 3 between the lifting units 15a, 15a′ and the stationary conveying system of the second conveying system 6, 6a. For this purpose, the transfer units can be configured like the first transfer unit 40 or the second transfer unit 41.

It is also conceivable for the further lifting device 14a of the second conveying system 6, 6a to comprise lifting units 15a, 15a′ configured to transfer an article 3 together with transport vehicles 4 between the article handover location and the second conveying system 6, 6a, wherein the second conveying system 6, 6a comprises a transfer unit for transferring an article 3 between the stationary conveying device of the second conveying system 6, 6a and a transport vehicle 4 provided by the lifting units 15, 15a′ at the second conveying system 6, 6a. For this purpose, the transfer unit can again be configured like the first transfer unit 40 or the second transfer unit 41.

Generally, it is also conceivable for a lifting unit 15a of the further lifting device 14a to be provided to lift an article 3 from the article handover location to the second conveying system 6, 6a and the other lifting unit 15a′ to be provided to lower an article 3 from the second conveying system 6, 6a to the article handover location. This way, the articles 3 can be moved according to the one-way system in the area of the loading station 1 . . . 1″, 1a. . . 1e.

The same applies for the lifting device 12a for the first conveying system 5, 5a, 5b. One lifting unit 13a of the lifting device 12a for the first conveying system 5, 5a, 5b can thus be provided to lift loading aids 2 from the loading aid handover location 8 to the first conveying system 5, 5a, 5b, and the other lifting unit 13a′ to lower loading aids 2 from the first conveying system 5, 5a, 5b to the loading aid handover location 8. This way, the loading aids 2 can also be moved according to the one-way system in the area of the loading station 1 . . . 1″, 1a . . . 1e.

It would also be conceivable for the stationary conveying device 27 of the second conveying system 6, 6a to adjoin a stationary conveying device of the storage system extending from an article storage of a storage system to the loading station 1, wherein the stationary conveying device of the storage system is also configured for transporting articles 3 (with or without loading aid 2) (also see FIG. 16). A separate further lifting device 14a for the second conveying system 6, 6a is then not required.

FIG. 9 shows a further example of a loading station 1f in top view. Specifically, it shows the driving surface 23 of a first conveying system 5c. On the one hand, the first conveying system 5c has two buffers 44, 44′ each with a plurality of buffer locations 45, 45′, and on the other hand a plurality of sorting buffers 46, 46′ with further buffer locations 45, 45′ or sorting locations 47, 47′. The sorting locations 47, 47′ are thereby only accessible via sorting driving surfaces 48. Specifically, the sorting driving surface 48 is arranged on the driving platform 10 and diverges from the driving surface 23 and merges into it again elsewhere.

Alternatively or in addition, a sorting driving surface 48′ can be provided which connects the second driving surface section 25 with the first driving surface section 24. A sorting of the loading aids 2 can also be performed in this way. Optionally, a sorting location 47, 47′ can also be provided on the sorting driving surface 48′. Furthermore, it is conceivable that a plurality of sorting driving surfaces 48′ are provided.

The buffers 44, 44′ serve to buffer loading aids 2 or transport vehicles 4 in order to be able to balance out fluctuations in the conveying flow. The buffer 44 is hereby arranged along the first conveying section 24 on the entry side, and the buffer 44′ is arranged along the second conveying section 25 on the exit side.

The sorting buffers 46, 46′ are configured to provide loading aids 2 or transport vehicles 4 sorted in a sequence. The sorting buffer 46 is thereby arranged along the first conveying section 24 on the entry side, and the sorting buffer 46′ is arranged along the second conveying section 25 on the exit side. Sections of the driving surface 23 and in particular the sorting driving surfaces 48, 48′ connect sorting locations 47, 47′ with the buffer locations 45, 45′ and can accordingly be understood as sorting conveying devices.

The disclosed structure is to be understood purely by way of example; the buffers 44, 44′ and the sorting buffers 46, 46′ can be provided in any number, in any size, and in any place. The buffers 44, 44′ and the sorting buffers 46, 46′ can also have a different structural configuration. The structure disclosed in FIG. 9 is not only utilizable in connection with driving surfaces 23 for transport vehicles 4, but is generally utilizable, for instance also if the first conveying system 5, 5b comprises a stationary conveying device 39.

The second conveying system 6 is not shown in detail in FIG. 9, but can have the same or a similar structure as the first conveying system 5, 5a, 5b. Specifically, the second conveying system 6 can comprise a sorting buffer 46, 46′ configured to provide articles 3 (with or without loading aid 2) sorted in a sequence and having a plurality of buffer locations 45, 45′ formed by the stationary conveying device 27 along the first conveying section 28 and a plurality of sorting locations 47, 47′ formed by the stationary conveying device 27 along the second conveying section 29, wherein the second conveying system 6 has a plurality of conveying sections connecting the sorting locations 47, 47′ with the buffer locations 45, 45′. Moreover, the stationary conveying device 27 of the second conveying system 6 can, alternatively or in addition, have a plurality of buffer locations 45, 45′ of a buffer 44, 44′, in particular along the first conveying section 28.

FIGS. 10 and 11 show, respectively, top views of a schematic representation of an assembly of loading stations 1, 1′ and of the driving area D lying below. For the sake of a better representation of the driving area D, the loading stations 1, 1′ are omitted from FIG. 11.

In this example, the driving zone A, specifically the driving area D, comprises a driving surface 49 drivable on by the transport vehicles 4. The driving surface 49 preferably forms a closed circulation, as is shown in FIGS. 10 and 11.

Preferably, the transport vehicles 4 can drive in one driving direction on the driving surface 49. If the driving surface 49 forms a closed circulation, the driving direction corresponds to a circulation direction.

The driving surface 49 can be arranged on a floor of a storage system, for example on a floor of a story of the storage system. Optionally, the loading station 1, 1′ can also comprise a lower platform arranged in the ground plane B1. The loading station 1, 1′ can be installed on this platform and/or the driving surface 49 of the driving zone A can be arranged thereon. For example, support structures for the loading station 1, 1′ can be positioned on this platform.

It is particularly preferable for the driving zone A to be configured as an open container, wherein a base plate of the container is formed by the platform and a cover plate of the container is formed by the driving platform 10.

It is also advantageous for the driving zone A to comprise a further driving surface 50, preferably forming a closed circulation, drivable on by transport vehicles 4, the further driving surface being arranged, in particular with a constant spacing d to the driving surface 49, extending next to the driving surface 49 and being connected to the driving surface 49 by a changeover driving surface 51 at at least one point, wherein the driving surface 49 and the further driving surface 50 are spaced apart from one another in such a way that transport vehicles 4 moving along the driving surface 49 and the further driving surface 50 can pass one another. This way, transport vehicles 4 can overtake one another, meaning that the conveying of the loading aids 2 and articles 3 can be made particularly efficient. In particular, such a procedure is also advantageous if transport vehicles 4 with different design speeds are moving in the driving zone A.

Preferably, the driving surface 49 and/or the further driving surface 50 are thereby drivable on in one, in particular in the same, driving direction. If the driving surface 49 and/or the further driving surface 50 each form a closed circulation, the driving direction corresponds to a respective circulation direction.

In the example shown in FIGS. 10 and 11, the driving surface 49 of the driving zone A and/or the further driving surface 50 of the driving zone A traverses the first conveying system 5, 5a, 5b, preferably at a right angle. The driving zone A below the first conveying system 5, 5a, 5b can thereby be made usable, in particular if a plurality of loading stations 1, 1′ are arranged one next to the other, as is the case in FIG. 10. That is indeed advantageous, although a different configuration would also be conceivable.

The driving zone A also has a provisioning driving surface 54 diverging from the driving surface 49 of the driving zone A at a point of exit 52 and merging into the driving surface 49 of the driving zone A at a point of entry 53 for providing transport vehicles 4 at the lifting system 7, 7a, in particular at the lifting device 12, 12a, or rather at the loading aid handover location 8, wherein the provisioning driving surface 54 extends from the point of exit 52 to the loading aid handover location 8 and from the loading aid handover location 8 to the point of entry 53. This way, transport vehicles 4 can drive to the loading aid handover location 8 without impeding traffic on the driving surface 49. In the same way, a (separate) provisioning driving surface for providing transport vehicles 4 can be provided at the article handover location. The provisioning driving surface 54 can also go past the loading aid handover location 8 and the article handover location.

Generally,
the driving surface 49 of the driving zone A
and optionally the further driving surface 50 of the driving zone A, the provisioning driving surface 54, the driving surface 23 of the first conveying system 5, 5a, 5b and/or the sorting driving surface 48 can each be marked with optical driving path markers which are detectable and followable by the transport vehicles 4.

This way, the transport vehicles 4 can be guided along predetermined paths in a simple way.

The driving paths can also be particularly flexibly adjusted to changing circumstances by rearranging the optical markers.

FIGS. 10 and 11 also show a controller 55 which controls the processes in the area of the loading station 1; its functions shall be explained in detail later.

FIG. 12 shows a schematic top view of a further assembly of loading stations 1 . . . 1″ arranged in a row. In this example, the driving surface 49 and/or the further driving surface 50 of the driving zone A each have a coupling zone 56 which is connectable with a coupling zone 56 of a, in particular structurally identical, further loading station 1′, 1″ arranged next to the loading station 1.

The coupling zone 56 preferably borders the previously described third or fourth boundary plane. It is particularly preferable for a first coupling zone 56 to border the third boundary plane and a second coupling zone 56 to border the fourth boundary plane. Driving surfaces 49, 50 of loading stations 1 . . . 1″ arranged next to one another are thereby connected with one another if the loading stations 1 . . . 1″ are positioned in such a way that the third boundary plane of one of the loading stations 1 adjoins the fourth boundary plane of another of the loading stations 1′, 1″. In particular, the assembly shown forms a loading station group 57.

It is preferably provided that the driving surfaces 49, 50 of the driving zones A of the loading stations 1 . . . 1″ are connected with one another and form a closed circulation, wherein the closed circulation extends across all loading stations 1 . . . 1″ of the loading station group 57.

The driving surfaces 49, 50 are preferably connected with one another by their coupling zones 56.

FIG. 13 to 15 show a somewhat more detailed example of a storage system 58a. FIG. 13 shows an oblique perspective view of the storage system 58a, FIG. 14 a perspective side view, and FIG. 15 a front perspective view. The storage system 58a comprises an article storage 59 and a plurality of loading stations 1 or rather a loading station group 57. FIG. 13 to 15 also show storage transport vehicles 60.

Finally, FIG. 16 shows a top view of a storage system 58b, again shown schematically. The storage system 58b comprises a storage zone 61 in which an article storage 59 is arranged, an order processing zone 62 in which at least one loading station 1 of the type disclosed is arranged, and a storage and retrieval conveying system 63 for transporting an article 3 between the storage zone 61 and the order processing zone 62, wherein the second conveying system 6, 6a of the loading station 1 is connected with the article storage 59 by the storage and retrieval conveying system 63.

The storage and retrieval conveying system 63 can have a storage driving zone 64 and autonomously movable, driverless transport vehicles 4 or rather storage transport vehicles 60 in the storage driving zone 64, wherein the storage driving zone 64 extends from the storage zone 61 to the lifting system 7, 7a, for example to the further lifting device 14, 14a, of the loading station 1, in particular to the article handover location 8.

The storage system 58b can also have the following optional components:
an order post-processing zone 65 with at least one working location 20 for the, in particular manual, performance of post-processing orders,
a transfer driving zone 66 extending from the driving zone 62 of the at least one loading station 1 to the order post-processing zone 65, and
a plurality of autonomously movable, driverless transport vehicles 4 in the driving zone 62 of the at least one loading station 1 and in the transfer driving zone 66 in order to transport loading aids 2.

In particular, the transport vehicles 4 can drive on transfer driving surfaces 67 in the transfer driving zone 66.

Post-processing orders can each be electronically acquired as a dataset and be processed, for example, by a warehouse management system. Post-processing orders are, as a rule, not picking orders. Thus, a post-processing order can follow a picking order as soon as one or more order lines of that picking order have been picked. A picking order comprises one or more order lines, wherein each order line denotes one (ordered) article by its article type and its (ordered) number of pieces. The post-processing orders comprise in particular one or more value added services, such as packaging, disposal, labelling, quality control of the article 3, an addition of a package insert or an invoice for the article 3 and the like. The at least one working location of the post-processing zone 65 can be configured so that various post-processing orders can be performed. For example, the post-processing orders “package a picked article” and “include a brochure” can be performed at one working location. A post-processing order can also comprise the offloading of the loading aid 2 onto a truck that subsequently exits the storage system 58b with the article 3. The processing order can also only comprise the offloading. The order post-processing zone 65 can then also be understood as an offloading zone.

A method for loading loading aids 2 with articles 3 using a loading station 1 . . . 1″, 1a . . . 1f of the type disclosed can have the following steps:
i) transporting an article 3 to the loading device 9, 9a using the second conveying system 6, 6a;
ii) providing the article 3 at the loading device 9, 9a, in particular at a removal location 19 of the article provisioning device 18;
iii) transporting a loading aid 2 to the lifting device 12, 12a using an autonomously movable, driverless transport vehicle 4, wherein the transport vehicle 4 is moved over the driving zone A of the loading station 1 . . . 1″ to the loading aid handover location 8;
iv) transferring the loading aid 2 from the loading aid handover location 8 to the first conveying system 5, 5a, 5b using the lifting device 12, 12a, in particular using the lifting unit 13a, 13a′;
v) transporting the loading aid 2 from the lifting device 12, 12a to the loading device 9, 9a using the first conveying system 5, 5a, 5b;
vi) providing the loading aid 2 at the loading device 9, 9a, in particular at a loading location 17 of the loading aid provisioning device 16;
vii) loading the loading aid 2 provided in step vi) with the article 3 provided in step ii) according to an order;
viii) transporting the loading aid 2 loaded with an article 3 using the first conveying system 5, 5a, 5b away from the loading device 9, 9a;
ix) transporting the loading aid 2 loaded with an article 3 to the lifting device 12, 12a using the first conveying system 5, 5a . . . 5c;
x) transferring the loading aid 2 loaded with an article 3 from the first conveying system 5, 5a, 5b to the loading aid handover location 8 using the lifting device 12, 12a;
xi) transporting the loading aid 2 loaded with an article 3 away from the lifting device 12, 12a using an autonomously movable, driverless transport vehicle 4, wherein the transport vehicle 4 is moved away from the loading aid handover location 8 over the driving zone A of the loading station 1 . . . 1″, 1a . . . 1f.

In step vii) an article 3 is removed, for example by a picker 21 or a loading robot 38, from the removal location 19, for example from a loading aid 2 containing an article 3 provided there, and is transferred to a loading aid 2 provided at the loading location 17.

If the first conveying system 5, 5a, 5b comprises a stationary conveying device 39, then
the loading aid 2 in step iv) can be handed over from the transport vehicle 4 to the lifting device 12, 12a, is transferred upwards using the lifting device 12, 12a and handed over to the stationary conveying device 39 of the first conveying system 5, 5a, 5b, and/or
the loading aid 2 in step x) loaded with an article 3 is handed over from the stationary conveying device of the first conveying system 5, 5a, 5b to the lifting device 12, 12a, is transferred downwards the lifting device 12, 12a and handed over to a transport vehicle 4 provided at the loading aid handover location 8.

The loading aid 2 together with the transport vehicle 4 in step iv) can be received by the lifting device 12, 12a, is transferred upwards using the lifting device 12, 12a, whereafter the loading aid 2 is handed over from the transport vehicle 4 to the stationary conveying device 39 of the first conveying system 5, 5a, 5b.

Alternatively or in addition, a transport vehicle 4 can be provided in step x) at the stationary conveying device of the first conveying system 5, 5a, 5b using the lifting device 12, 12a, whereafter the loading aid 2 loaded with an article 3 is handed over from the stationary conveying device of the first conveying system 5, 5a, 5b to the transport vehicle 4 provided, whereafter the transport vehicle 4 together with the loading aid 2 loaded with an article 3 is transferred downwards to the loading aid handover location 8 by the lifting device 12, 12a.

In step v), the loading aid 2, and in steps viii) and ix) the loading aid 2 loaded with an article 3 can be transported by the stationary conveying device 39 of the first conveying system 5, 5a, 5b.

Steps v) and/or ix) can also comprise a sorting of loading aids 2 by the first conveying system 5, 5a, 5b, wherein a loading aid 2, in particular loaded with an article 3, is transferred using a sorting conveying device 48 from a sorting location 47, 47′ configured on the stationary conveying device to a buffer location 45, 45′ configured on the stationary conveying device.

If the first conveying system 5, 5a, 5b has a driving platform 10 for transport vehicles 4, the transportation of the loading aid 2 in step v) and of the loading aid 2 loaded with an article 3 in steps viii), x) can then be performed using an autonomously movable, driverless transport vehicle 4 and the transport vehicle 4
in step iv) together with the loading aid 2 can be transferred from the loading aid handover location 8 to the driving platform 10 of the first conveying system 5, 5a, 5b by the lifting device 12, 12a, whereafter the transport vehicle 4 together with the loading aid 2 moves from the lifting device 12, 12a onto the driving platform 10, and/or
in step x) together with the loading aid 2 loaded with an article 3 moves from the driving platform 10 into the lifting device 12, 12a, whereafter the transport vehicle 4 is transferred from the driving platform 10 to the loading aid handover location 8 using the lifting device 12, 12a.

The transport vehicle 4 in steps v), viii) and ix) can drive on the driving platform 10 on a driving surface 23 extending from the lifting device 12, 12a to the loading device 9, 9a and from the loading device 9, 9a to the lifting device 12, 12a, in particular along a closed circulation.

Steps v) and/or viii) can comprise a sorting of loading aids 2 by the first conveying system 5, 5a, 5b, wherein the transport vehicle 4 together with the loading aid 2, in particular loaded with an article 3, moves onto a sorting driving surface 48, 48′ diverging from the driving surface 23 of the first conveying system 5, 5a, 5b and another transport vehicle 4 together with the loading aid 2, in particular loaded with an article 3, moves on the driving surface 23 of the first conveying system 5, 5a, 5b, such that the transport vehicle 4 and the other transport vehicle 4 are moved past one another, whereafter the transport vehicle 4 moves back from the sorting driving surface 48, 48′ onto the driving surface 23 of the first conveying system 5, 5a, 5b.

Generally, an order can comprise a plurality of order lines, wherein steps i) and ii) as well as vii) and viii) are performed for an article 3 of a first order line and are subsequently repeated for an article 3 of a second order line, wherein the transport vehicle 4, after step vii) has been performed for the article 3 of the first order line, moves onto a sorting driving surface 48, 48′ diverging from the driving surface 23 of the first conveying system 5, 5a, 5b and is buffered on the sorting driving surface 48, 48′ or a sorting location 47, 47′ until such a time as step i) is performed for the article 3 of the second order line, and subsequently moves from the sorting driving surface 48, 48′ onto the driving surface 23 of the first conveying system 5, 5a, 5b and along the driving surface 23 to the loading device 9, 9a, whereafter steps vii) and viii) are repeated for the article 3 of the second order line.

Furthermore, it is conceivable that step iii) is performed for a further loading aid 2, while step v) is performed for the loading aid 2 and/or one or more of steps viii) and ix) are performed for the loading aid 2 loaded with an article 3, wherein the further loading aid 2 is moved underneath the driving surface 23 of the first conveying system 5, 5a, 5b, in particular underneath the loading aid 2. The loading station 1 . . . 1″ can thereby be operated in a particularly efficient manner.

In a further variation of the proposed method, it can also be provided that in step i) an article 3 is handed over by an autonomously movable, driverless transport vehicle 4, 60, in particular of a storage and retrieval conveying system 63 of a storage system 58a, 58b of the type disclosed, in a storage driving zone 64, preferably on a storage driving surface, to the loading station 1 . . . 1″ and is handed over to it, in particular to the second conveying system 6, 6a of the loading station 1 . . . 1″.

It can thereby be provided that the transport vehicles 4, 60 of the storage and retrieval conveying system 63 are moved by the further lifting system 14, 14a to the second conveying system 6, 6a, whereafter the article 3 is handed over to the second conveying system 6, 6a.

Alternatively, it can be provided that the article 3 is transported to the article handover location by the transport vehicles 4, 60 and handed over to the further lifting device 14, 14a. The article 3 can thereby be moved by the further lifting device 14, 14a to the second conveying system 6, 6a and be handed over to it.

In a further variation of the disclosed method, the loading aid 2 provided in step vii) can be loaded with articles 3 of a plurality of (different) orders. Articles 3 of a plurality of orders can thereby be transported away from the loading station 1 . . . 1″ and, for example, be taken to an order post-processing zone 65 in a single step.

It is also conceivable that steps iii) to vii) are repeated for a plurality of loading aids 2 by one transport vehicle 4 each and that step vii) is repeated for articles 3 of one article type provided in step i) for a plurality of orders for the loading aids 2 provided one after the other. The loading of a plurality of loading aids 2 can thereby be performed particularly efficiently, since in step i) articles 3 of one (single) article type are provided for a plurality of loading aids 2.

Finally, it is particularly advantageous for the second conveying system 6, 6a to comprise a plurality of buffer locations 45, 45′ and step i) to be repeated for articles 3 of different article types, wherein the articles 3 are buffered at the buffer locations 45, 45′. It is thereby possible to load loading aids 2 with articles 3 of a different article type without the articles 3 having to be provided from the article storage 59 each time. Rather, they are intermediately buffered in the second conveying system 6, 6a as required.

It should be noted here that the proposed method can be performed in particular under the control of the controller 55. This is not necessarily to be understood as a single device, as it is shown symbolically, but rather it can also be constituted by or comprise distributed control devices. For example, such control units can be contained in the loading station 1 . . . 1″, 1a . . . 1f.

Finally, it should be noted that the scope of protection is defined by the claims. However, the description and the drawings should be consulted when construing the claims. Individual features or combinations of features from the various example embodiments as shown and described can constitute separate inventive solutions. The problem to be solved by the individual inventive solutions can be derived from the description.

In particular, it should be noted that in reality the represented devices can comprise more or fewer components than shown. The represented devices and their components can partially also be shown not to scale and/or in magnification and/or shrunk down.

### LIST OF REFERENCE NUMERALS

1 . . . 1″, 1a . . . 1f Loading station
2 Loading aid
3 Article
4 Driverless transport vehicle
5, 5a . . . 5c First conveying system
6,6a Second conveying system
7,7a Lifting system
8 Loading aid handover location
9,9a Loading device
10 Support structure (driving platform)
11 Support structure (upright)
12, 12a Lifting device for first conveying system
13, 13a . . . 13d Lifting unit for first conveying system
14, 14a Further lifting device for second conveying system
15a, 15a′ Lifting unit for second conveying system
16 Loading aid provisioning device
17 Loading location
18 Article provisioning device
19 Removal location
20 Working location for manual loading
21 Worker/picker
22 Pedestal
23 Driving surface first conveying system
24 First conveying section/driving surface section first conveying system
25 Second conveying section/driving surface section first conveying system
26 Third conveying section/driving surface section first conveying system
27 Stationary conveying device second conveying system
28 First conveying section second conveying system
29 Second conveying section second conveying system
30 Third conveying section second conveying system
31 Upright
32 Lifting platform
33 Ramp
34 Chassis
35 Wheel
36 Loading platform
37a, 37b Provisioning driving platform
38 Loading robot
39 Stationary conveying device first conveying system
40 First transfer unit (for loading aids)
41 Second transfer unit (for loading aids)
42a, 42b Ramp
43 Shared driving zone
44,44′ Buffer
45,45′ Buffer location
46, 46′ Sorting buffer
47,47′ Sorting location
48, 48′ Sorting driving surface/sorting conveying device
49 Driving surface
50 Further driving surface
51 Changeover driving surface
52 Point of exit
53 Point of entry
54 Provisioning driving surface
55 Controller
56 Coupling zone
57 Loading station group
58a, 58b Storage system
59 Article storage
60 Storage transport vehicle
61 Storage zone
62 Order processing zone
63 Storage and retrieval conveying system
64 Storage driving zone
65 Order post-processing zone
66 Transfer driving zone
67 Transfer driving surface
a Vertical spacing
b Horizontal spacing
c Provisioning height
d Constant (driving surface) spacing
x Horizontal (longitudinal) direction
y Horizontal (transverse) direction
z Vertical direction
A Driving zone
B1 Ground plane
B2 Cover plane
C1 First boundary plane
C2 Second boundary plane
D Driving area

1: A loading station (1 . . . 1″, 1a . . . 1f) for loading articles (3) into loading aids (2), the loading station (1 . . . 1″, 1a . . . 1f) comprising
a driving zone (A) in which autonomously movable, driverless transport vehicles (4) for transporting loading aids (2) are movable,
a ground plane (B1) and a cover plane (B2) opposite the ground plane (B1) at a vertical spacing (a), wherein the ground plane (B1) and the cover plane (B2) delimit the driving zone (A) in a vertical direction (z),
a first boundary plane (C1) and a second boundary plane (C2) opposite the first boundary plane (C1) at a horizontal spacing (b), each intersecting the ground plane (B1) and the cover plane (B2) and delimiting the driving zone (A) in a horizontal direction (x),
a first conveying system (5, 5a . . . 5c) for transporting loading aids (2),
a second conveying system (6, 6a) for transporting articles (3),
a lifting system (7, 7a) having a lifting device (12, 12a) aligned with a side of the first boundary plane (C1) facing away from the driving zone (A) for transferring loading aids (2) between a loading aid handover location (8) arranged below the cover plane (B2) on the lifting device and the first conveying system (5, 5a . . . 5c), a loading device (9, 9a) aligned with a side of the second boundary plane (C2) facing away from the driving zone (A) for loading into loading aids (2) articles (3) provided at the loading device (9, 9a),
wherein the first conveying system (5, 5a . . . 5c) and the second conveying system (6, 6a) each extend between the first and second boundary planes (C1, C2) and the first conveying system (5, 5a . . . 5c) connects the lifting device (12, 12a) with the loading device (9, 9a), wherein
the vertical spacing (a) between the ground plane (B1) and the cover plane (B2) corresponds at least to a clearance height for transport vehicles (4) each loaded with a loading aid (2), and
the first conveying system (5, 5a . . . 5c) and the second conveying system (6, 6a) are arranged above the driving zone (A).

2: The loading station (1 . . . 1″, 1a . . . 1f) according to claim 1, wherein the driving zone (A) comprises a driving surface (49), preferably forming a closed circulation, wherein transport vehicles (4) are drivable on the driving surface (49).

3: The loading station (1 . . . 1″, 1a . . . 1f) according to claim 2, wherein the driving zone (A) comprises a further driving surface (50), preferably forming a closed circulation, drivable on by transport vehicles (4), the further driving surface being arranged, in particular with a constant spacing (d) to the driving surface (49), extending next to the driving surface (49) and being connected to the driving surface (49) at at least one point, wherein the driving surface (49) and the further driving surface (50) are spaced apart from one another in such a way that transport vehicles (4) moving along the driving surface (49) and the further driving surface (50) can pass one another.

4: The loading station (1 . . . 1″, 1a . . . 1f) according to claim 2, wherein the driving surface (49) of the driving zone (A) and/or the further driving surface (50) of the driving zone (A) traverses the first conveying system (5, 5a . . . 5c), preferably at a right angle.

5: The loading station (1 . . . 1″, 1a . . . 1f) according to claim 2, wherein the driving zone (A) has a provisioning driving surface (54) diverging from the driving surface (49) of the driving zone (A) at a point of exit (52) and merging into the driving surface (49) of the driving zone (A) at a point of entry (53) for providing transport vehicles (4) at the loading aid handover location (8), wherein the provisioning driving surface (54) extends from the point of exit (52) to the loading aid handover location (8) and from the loading aid handover location (8) to the point of entry (53).

6: The loading station (1 . . . 1″, 1a . . . 1f) according to claim 2, wherein the driving zone (A) has a driving area (D) arranged in the ground plane (B1), on which driving area (D) the transport vehicles (4) are movable, wherein the driving surface (49) and/or the further driving surface (50) are arranged on the driving area (D) of the driving zone (A).

7: The loading station (1 . . . 1″, 1a . . . 1f) according to claim 2, wherein the driving surface (49) and/or the further driving surface (50) of the driving zone (A) each have a coupling zone (56) which is connectable with a coupling zone (56) of a, in particular structurally identical, further loading station (1 . . . 1″, 1a . . . 1f) arranged next to the loading station (1 . . . 1″, 1a . . . 1f).

8: The loading station (1 . . . 1″, 1a . . . 1f) according to claim 1, wherein the loading device (9, 9a) has a loading aid provisioning device (16) for providing loading aids (2) at a loading location (17).

9: The loading station (1 . . . 1″, 1a . . . 1f) according to one claim 1, wherein the loading device (9, 9a) has an article provisioning device (18) for providing an article (3) at a removal location (19).

10: The loading station (1 . . . 1″, 1a . . . 1f) according to claim 8, wherein the loading aid provisioning device (16) and the article provisioning device (18) are configured to provide loading aids (2) and articles (3) at a provisioning height (c), in particular an ergonomic height for manually loading the loading aids (2).

11: The loading station (1 . . . 1″, 1a . . . 1f) according to claim 8, wherein the loading device (9, 9a) has a working location (20) for manually loading into loading aids (2) provided at the loading location (17) articles (3) provided at the removal location (19).

12: The loading station (1 . . . 1″, 1a . . . 1f) according to claim 8, wherein the loading device (9, 9a) has a loading robot (38) for automated loading of loading aids (2) provided at the loading location (17) with articles (3) provided at the removal location (19).

13: The loading station (1 . . . 1″, 1a . . . 1f) according to claim 1, wherein the first conveying system (5, 5a. . . 5c) comprises a stationary conveying device (39), preferably forming a closed circulation, for transporting loading aids (2) between the first and second boundary plane (C1, C2), in particular between the lifting device (12, 12a) and the loading device (9, 9a).

14: The loading station (1 . . . 1″, 1a . . . 1f) according to claim 13, wherein the stationary conveying device (39) of the first conveying system (5, 5a . . . 5c) has a first conveying section (24) extending from the first to the second boundary plane (C1, C2), in particular from the lifting device (12, 12a) to the loading device (9, 9a), and a second conveying section (25) extending from the second to the first boundary plane (C2, C1), in particular from the loading device (9, 9a) to the lifting device (12, 12a).

15: The loading station (1 . . . 1″, 1a . . . 1f) according to claim 8, wherein the stationary conveying device (39) of the first conveying system (5, 5a . . . 5c) has a third conveying section (26) connecting the first and second conveying sections (24, 25), forming the loading aid provisioning device (16) and the loading location (17).

16: The loading station (1 . . . 1″, 1a . . . 1f) according to claim 14, wherein the first conveying system (5, 5a . . . 5c) comprises a sorting buffer (46, 46′) configured to provide loading aids (2) sorted in a sequence and having a plurality of buffer locations (45, 45′) formed by the stationary conveying device (39) along the first conveying section (24) and a plurality of sorting locations (47, 47′) formed by the stationary conveying device (39) along the second conveying section (25), wherein the first conveying system (5, 5a . . . 5c) has a plurality of sorting conveying devices (48, 48′) connecting the sorting locations (47, 47′) with the buffer locations (45, 45′).

17: The loading station (1 . . . 1″, 1a . . . 1f) according to claim 13, wherein the lifting device (12, 12a) comprises a lifting unit (13, 13a . . . 13d) configured to transfer loading aids (2) between the loading aid handover location (8) and the first conveying system (5, 5a . . . 5c), wherein the lifting unit (13, 13a . . . 13d) has a first transfer unit (40) configured to transfer a loading aid (2) between a transport vehicle (4) provided at the loading aid handover location (8) and the lifting unit (13, 13a . . . 13d) as well as a second transfer unit (41) configured to transfer a loading aid (2) between the lifting unit (13, 13a . . . 13d) and the stationary conveying device (39) of the first conveying system (5, 5a . . . 5c).

18: The loading station (1 . . . 1″, 1a . . . 1f) according to claim 13, wherein the loading aid handover location (8) lies in the ground plane (B1) and the lifting device (12, 12a) comprises a lifting unit (13, 13a . . . 13d) configured to transfer loading aids (2) together with transport vehicles (4) between the loading aid handover location (8) and the first conveying system (5, 5a . . . 5c), wherein the first conveying system (5, 5a . . . 5c) comprises a first transfer unit (41) configured for transferring loading aids (2) between the stationary conveying device (39) of the first conveying system (5, 5a . . . 5c) and a transport vehicle (4) provided by the lifting unit (13, 13a . . . 13d) at the first conveying system (5, 5a . . . 5c).

19: The loading station (1 . . . 1″, 1a . . . 1f) according to claim 1, wherein the first conveying system (5, 5a . . . 5c) has a driving platform (10) arranged above the cover plane (B2), on which platform the transport vehicles (4) are movable, wherein the driving platform (10) extends from the first boundary plane (C1) to the second boundary plane (C2).

20: The loading station (1 . . . 1″, 1a . . . 1f) according to claim 8, wherein the loading aid provisioning device (16) has a provisioning driving platform (37a, 37b) adjoining the driving platform (10) or arranged on the driving platform (10), the provisioning driving platform (37a, 37b) being, at least partially, inclined upwards or downwards in relation to the driving platform (10).

21: The loading station (1 . . . 1″, 1a . . . 1f) according to claim 19, wherein the first conveying system (5, 5a . . . 5c) comprises a driving surface (23), preferably forming a closed circulation, arranged on the driving platform (10) and drivable on by the transport vehicles (4).

22: The loading station (1 . . . 1″, 1a . . . 1f) according to claim 21, wherein the driving surface (23) of the first conveying system (5, 5a . . . 5c) has a first driving surface section (24) extending from the first to the second boundary plane (C1, C2) and a second driving surface section (25) extending from the second to the first boundary plane (C2, C1).

23: The loading station (1 . . . 1″, 1a . . . 1f) according to claim 8, wherein the driving surface (23) of the first conveying system (5, 5a . . . 5c) has a third conveying section (26) connecting the first and second conveying sections (24, 25), forming the loading aid provisioning device (16) and the loading location (17).

24: The loading station (1 . . . 1″, 1a . . . 1f) according to claim 8, wherein the loading aid provisioning device (16) comprises a stationary conveying device (39) and a transfer device configured to transfer loading aids (2) between transport vehicles (4) on the driving surface (23) of the first conveying system (5, 5a . . . 5c) and the stationary conveying device (39) of the loading aid provisioning device (16).

25: The loading station (1 . . . 1″, 1a . . . 1f) according to claim 21, wherein the first conveying system (5, 5a . . . 5c) has at least one sorting driving surface (48, 48′) arranged on the driving platform (10) and diverging from the driving surface (23) and merging into the driving surface (23) elsewhere.

26: The loading station (1 . . . 1″, 1a . . . 1f) according to claim 19, wherein the lifting device (12, 12a) has a lifting unit (13, 13a . . . 13d) for transferring loading aids (2) together with the transport vehicles (4) between the loading aid handover location (8) and the driving platform (10).

27: The loading station (1 . . . 1″, 1a . . . 1f) according to claim 18, wherein the lifting unit (13, 13a . . . 13d) has a vertically movable lifting platform (32) on which one of the transport vehicles (4) together with the loading aid (2) is positionable in order to transfer the loading aid (2).

28: The loading station (1 . . . 1″, 1a . . . 1f) according to claim 18, wherein the lifting unit (13, 13a . . . 13d) has a ramp (42a, 42b) or climbing structure (31) connecting the ground plane (B1) and the first conveying system (5, 5a . . . 5c) and/or the driving platform (10), wherein the transport vehicles (4) are movable along the ramp (42a, 42b) or the climbing structure (31).

29: The loading station (1 . . . 1″, 1a . . . 1f) according to claim 17, wherein the lifting device (12, 12a) has two such lifting units (13, 13a . . . 13d), wherein one of the lifting units (13, 13a . . . 13d) of the lifting device (12, 12a) is provided for lifting loading aids (2) from the loading aid handover location (8) to the first conveying system (5, 5a . . . 5c) and the other of the lifting units (13, 13a . . . 13d) of the lifting device (12, 12a) is provided for lowering loading aids (2) from the first conveying system (5, 5a . . . 5c) to the loading aid handover location (8).

30: The loading station (1 . . . 1″, 1a . . . 1f) according to claim 1, wherein the lifting system (7, 7a) has a further lifting device (14, 14a) for transferring an article (3) between an article handover location arranged beneath the cover plane (B2) and the second conveying system (6, 6a), wherein the second conveying system (6, 6a) connects the further lifting device (14, 14a) with the loading device (9, 9a).

31: The loading station (1 . . . 1″, 1a . . . 1f) according to claim 1, wherein the second conveying system (6, 6a) comprises a stationary conveying device (27), preferably forming a closed circulation, for transporting articles (3) between the first and second boundary planes (C1, C2).

32: The loading station (1 . . . 1″, 1a . . . 1f) according to claim 31, wherein the stationary conveying device (27) of the second conveying system (6, 6a) has a first conveying section (28) extending from the first to the second boundary plane (C1, C2) and a second conveying section (29) extending from the second to the first boundary plane (C2, C1).

33: The loading station (1 . . . 1″, 1a . . . 1f) according to claim 9, wherein the stationary conveying device (27) of the second conveying system (6, 6a) has a third conveying section (30) connecting the first and second conveying sections (28, 29), the third conveying section (30) forming the article provisioning device (18) and the loading location (17).

34: The loading station (1 . . . 1″, 1a . . . 1f) according to claim 32, wherein the second conveying system (6, 6a) comprises a sorting buffer (46, 46′) configured to provide articles (3) sorted in a sequence and having a plurality of buffer locations (45, 45′) along the first conveying section (28) formed by the stationary conveying device (27) and a plurality of sorting locations (47, 47′) along the second conveying section (29) formed by the stationary conveying device (27), wherein the second conveying system (6, 6a) has a plurality of sorting conveying devices (48, 48′) connecting the sorting locations (47, 47′) with the buffer locations (45, 45′).

35: The loading station (1 . . . 1″, 1a . . . 1f) according to claim 30, wherein the stationary conveying device (27) of the second conveying system (6, 6a) forms a plurality of buffer locations (45, 45′), in particular along the first conveying section (28).

36: The loading station (1 . . . 1″, 1a . . . 1f) according to claim 30, and wherein the further lifting device (14, 14a) comprises a lifting unit (15, 15a′) for transferring an article (3) between an article handover location arranged below the cover plane (B2) and the second conveying system (6, 6a), wherein the lifting unit (15, 15a′) has a first transfer unit for transferring an article (3) between the lifting unit (15, 15a′) and a transport vehicle (4) provided at the article handover location as well as a second transfer unit for transferring an article (3) between the lifting unit (15, 15a′) and the stationary conveying device (27) of the second conveying system (6, 6a).

37: The loading station (1 . . . 1″, 1a . . . 1f) according to claim 30, wherein the further lifting device (14, 14a) comprises a lifting unit (15, 15a′) configured to transfer articles (3) together with the transport vehicles (4) between the article handover location and the second conveying system (6, 6a) and wherein the second conveying system (6, 6a) comprises a transfer unit configured for transferring an article (3) between the stationary conveying device (27) of the second conveying system (6, 6a) and a transport vehicle (4) provided by the lifting unit (15, 15a′) at the second conveying system (6, 6a).

38: The loading station (1 . . . 1″, 1a . . . 1f) according to claim 36, wherein the further lifting device (14, 14a) has two such lifting units (15, 15a′), wherein one of the lifting units (15, 15a′) of the further lifting device (14, 14a) is provided for lifting an article (3) from the article handover location to the second conveying system (6, 6a) and the other of the lifting units (15, 15a′) of the further lifting device (14, 14a) is provided for lowering an article (3) from the second conveying system (6, 6a) to the article handover location.

39: The loading station (1 . . . 1″, 1a . . . 1f) according to claim 1, wherein the loading station (1 . . . 1″, 1a . . . 1f) has a plurality of autonomously movable, driverless transport vehicles (4) configured for transporting loading aids (2) and for moving in the driving zone (A) in the ground plane (B1).

40: The loading station (1 . . . 1″, 1a . . . 1f) according to claim 19, wherein the transport vehicles (4) are movable alternately and/or selectively in the ground plane (B1) or the driving platform (10).

41: The loading station (1 . . . 1″, 1a . . . 1f) according to claim 39, wherein the transport vehicles (4) each have a chassis (34) with a drive unit and a loading platform (36) arranged on the chassis (34) configured to receive a loading aid (2).

42: The loading station (1 . . . 1″, 1a . . . 1f) according to claim 41, wherein the loading platform (36) is movable between a transport position and a provisioning position in order to provide loading aids (2) at the loading device (9, 9a) at an ergonomic height (c) for loading.

43: The loading station (1 . . . 1″, 1a . . . 1f) according to any claim 1, wherein the loading station (1 . . . 1″, 1a . . . 1f) comprises a first support structure (10, 11) on which the first conveying system (5, 5a . . . 5c) is mounted and/or a second support structure (10, 11) on which the second conveying system (6, 6a) is mounted.

44: The loading station (1 . . . 1″, 1a . . . 1f) according to claim 2, wherein
the driving surface (49) of the driving zone (A) and
optionally the further driving surface (50) of the driving zone (A), the provisioning driving surface (54), the driving surface (23) of the first conveying system (5, 5a . . . 5c) and/or the sorting driving surface (48, 48′) are each marked with optical driving path markers which are detectable and followable by the transport vehicles (4).

45: The loading station (1 . . . 1″, 1a . . . 1f) according to claim 1, wherein a horizontal spacing (b) between the first and second boundary plane (C1, C2) corresponds at least to a width of two transport vehicles (4) arranged one next to the other.

46: A loading station group (57) comprising a plurality of loading stations (1 . . . 1″, 1a . . . 1f) according to claim 1, wherein the driving zones (A) of the loading stations (1 . . . 1″, 1a . . . 1f) are connected with one another.

47: A storage system (58a, 58b) with a storage zone (61) in which an article storage (59) is arranged, an order processing zone (62) in which at least one loading station (1 . . . 1″, 1a . . . 1f) is arranged, and a storage and retrieval conveying system (63) for transporting an article (3) between the storage zone (61) and the order processing zone (62), wherein the loading station (1 . . . 1″, 1a . . . 1f) is configured according to claim 1 and the second conveying system (6, 6a) of the loading station (1 . . . 1″, 1a . . . 1f) is connected with the article storage (59) by the storage and retrieval conveying system (63).

48: The storage system (58a, 58b) according to claim 47, wherein the storage and retrieval conveying system (63) has a storage driving zone (64) and autonomously movable, driverless transport vehicles (4, 60) in the storage driving zone (64), wherein the storage driving zone (64) extends from the storage zone (61) to the lifting system (7, 7a) of the loading station (1 . . . 1″, 1a . . . 1f).

49: The storage system (58a, 58b) according to claim 47, wherein the storage system (58a, 58b) has
an order post-processing zone (65) with at least one working location for performing post-processing orders, in particular manually,
a transfer driving zone (66) extending from the driving zone (A) of the at least one loading station (1 . . . 1″, 1a . . . 1f) to the order post-processing zone (65), and
a plurality of autonomously movable, driverless transport vehicles (4) in the driving zone (A) of the at least one loading station (1 . . . 1″, 1a . . .1f) and in the transfer driving zone (66) in order to transport loading aids (2).

50: A storage system (58a, 58b) according to claim 47, wherein the storage system (58a, 58b) has a plurality of loading stations (1 . . . 1″, 1a . . . 1f) according to any one of claims 1 to 45 arranged next to one another, wherein the driving zones (A) of the loading stations (1 . . . 1″, 1a . . . 1f) are connected with one another.

51: A method for loading loading aids (2) with articles (3) using the loading station (1 . . . 1″, 1a . . . 1f) according to claim 1, further comprising the steps:
i) transporting an article (3) to the loading device (9, 9a) using the second conveying system (6, 6a);
ii) providing the article (3) at the loading device (9, 9a);
iii) transporting a loading aid (2) to the lifting device (12, 12a) using an autonomously movable, driverless transport vehicle (4), wherein the transport vehicle (4) is moved over the driving zone (A) of the loading station (1 . . . 1″, 1a . . . 1f) to the loading aid handover location (8);
iv) transferring the loading aid (2) from the loading aid handover location (8) to the first conveying system (5, 5a . . . 5c) using the lifting device (12, 12a);
v) transporting the loading aid (2) from the lifting device (12, 12a) to the loading device (9, 9a) using the first conveying system (5, 5a . . . 5c);
vi) providing the loading aid (2) at the loading device (9, 9a);
vii) loading the loading aid (2) provided in step vi) with the article (3) provided in step ii) according to an order;
viii) transporting the loading aid (2) loaded with an article (3) using the first conveying system (5, 5a . . . 5c) away from the loading device (9, 9a);
ix) transporting the loading aid (2) loaded with an article (3) to the lifting device (12, 12a) using the first conveying system (5, 5a . . . 5c);
x) transferring the loading aid (2) loaded with an article (3) from the first conveying system (5, 5a . . . 5c) to the loading aid handover location (8) using the lifting device (12, 12a);
xi) transporting the loading aid (2) loaded with an article (3) away from the lifting device (12, 12a) using an autonomously movable, driverless transport vehicle (4), wherein the transport vehicle (4) is moved away from the loading aid handover location (8) over the driving zone (A) of the loading station (1 . . . 1″, 1a . . . 1f).

52: The method according to claim 51, wherein
the loading aid (2) in step iv) is handed over from the transport vehicle (4) to the lifting device (12, 12a), is transferred upwards using the lifting device (12, 12a) and handed over to a stationary conveying device (39) of the first conveying system (5, 5a . . . 5c), and/or
the loading aid (2) in step x) loaded with an article (3) is handed over from the stationary conveying device (39) of the first conveying system (5, 5a . . . 5c) to the lifting device (12, 12a), is transferred downwards using the lifting device (12, 12a) and handed over to a transport vehicle (4) provided at the loading aid handover location (8).

53: The method according to claim 51, wherein
the loading aid (2) together with the transport vehicle (4) in step iv) is received from the lifting device (12, 12a), is transferred upwards using the lifting device (12, 12a), whereafter the loading aid (2) is handed over from the transport vehicle (4) to a stationary conveying device (39) of the first conveying system (5, 5a . . . 5c), and/or a transport vehicle (4) is provided in step x) at the stationary conveying device of the first conveying system (5, 5a . . . 5c) using the lifting device (12, 12a), whereafter the loading aid (2) loaded with an article (3) is handed over from the stationary conveying device (39) of the first conveying system (5, 5a . . . 5c) to the transport vehicle (4) provided, whereafter the transport vehicle (4) together with the loading aid (2) loaded with an article (3) is transferred downwards to the loading aid handover location (8) using the lifting device (12, 12a).

54: The method according to claim 52, wherein the loading aid (2) in step v) and the loading aid (2) loaded with an article (3) in steps viii) and ix) are transported by the stationary conveying device (39) of the first conveying system (5, 5a . . . 5c).

55: The method according to claim 54, wherein step(s) v) and/or ix) comprise(s) a sorting of loading aids (2) using the first conveying system (5, 5a . . . 5c), wherein a loading aid (2), in particular loaded with an article (3), is transferred by a sorting conveying device (48, 48′) from a sorting location (47, 47′) provided on the stationary conveying device to a buffer location (45, 45′) provided on the stationary conveying device (39).

56: The method according to claim 51, wherein the transportation of the loading aid (2) in step v) and of the loading aid (2) loaded with an article (3) in steps viii) and ix) is performed using an autonomously movable, driverless transport vehicle (4) and the transport vehicle (4)
in step iv) together with the loading aid (2) is transferred from the loading aid handover location (8) to a driving platform (10) of the first conveying system (5, 5a . . . 5c) using the lifting device (12, 12a), whereafter the transport vehicle (4) together with the loading aid (2) moves from the lifting device (12, 12a) onto the driving platform (10), and/or
in step x) together with the loading aid (2) loaded with an article (3) moves from the driving platform (10) into the lifting device (12, 12a), whereafter the transport vehicle (4) is transferred from the driving platform (10) to the loading aid handover location (8) using the lifting device (12, 12a).

57: The method according to claim 56, wherein the transport vehicle (4) in steps v), viii) and ix) moves on the driving platform (10) on a driving surface (23) of the first conveying system (5, 5a . . . 5c), the driving surface (23) extending from the lifting device (12, 12a) to the loading device (9, 9a) and from the loading device (9, 9a) to the lifting device (12, 12a), in particular along a closed circulation.

58: The method according to claim 57, wherein steps v) and/or viii) comprise a sorting of loading aids (2) by the first conveying system (5, 5a . . . 5c), wherein the transport vehicle (4) together with the loading aid (2), in particular loaded with an article (3), moves onto a sorting driving surface (48, 48′) diverging from the driving surface (23) of the first conveying system (5, 5a . . . 5c) and another transport vehicle (4) together with the loading aid (2), in particular loaded with an article (3), moves on the driving surface (23) of the first conveying system (5, 5a . . . 5c), such that the transport vehicle (4) and the other transport vehicle (4) are moved past one another, whereafter the transport vehicle (4) moves from the sorting driving surface (48, 48′) onto the driving surface (23) of the first conveying system (5, 5a . . . 5c).

59: The method according to claim 58, wherein the order comprises a plurality of order lines and steps i) and ii) as well as vii) and viii) are performed for an article (3) of a first order line and are subsequently repeated for an article (3) of a second order line, wherein the transport vehicle (4), after step vii) has been performed for the article (3) of the first order line, moves onto a sorting driving surface (48, 48′) diverging from the driving surface (23) of the first conveying system (5, 5a . . . 5c) and is buffered on the sorting driving surface (48, 48′) until such a time as step i) is performed for the article (3) of the second order line, and subsequently moves from the sorting driving surface (48, 48′) onto the driving surface (23) of the first conveying system (5, 5a . . . 5c) and along the driving surface (23) to the loading device (9, 9a), whereafter steps vii) and viii) are repeated for the article (3) of the second order line.

60: The method according to claim 51, wherein step iii) is performed for a further loading aid (2), while step v) is performed for the loading aid (2) and/or one or more of steps viii) and ix) are performed for the loading aid (2) loaded with an article (3), wherein the further loading aid (2) is moved underneath the driving surface (23) of the first conveying system (5, 5a . . . 5c), in particular underneath the loading aid (2).

61: The method according to claim 51, wherein in step i) an article (3) is transported using an autonomously movable, driverless transport vehicle (4, 60), in particular of a storage and retrieval conveying system (63) of a storage system (58a, 58b) according to any one of claims 47 to 50, in a storage driving zone (64), preferably on a storage driving surface, to the loading station (1 . . . 1″, 1a . . . 1f) and is handed over to the loading station (1 . . . 1″, 1a . . . 1f), in particular to the second conveying system (6, 6a) of the loading station (1 . . . 1″, 1a . . . 1f).

62: The method according to claim 51, wherein the loading aid (2) provided is loaded with articles (3) of a plurality of orders in step vii).

63: The method according to claim 51, wherein steps iii) to vii) are repeated for a plurality of loading aids (2) using one transport vehicle (4) each and step vii) is repeated for the loading aids (2) provided one after the other for an article (3) provided in step i) of one article type for a plurality of orders.

64: The method according to claim 51, wherein the second conveying system (6, 6a) comprises a plurality of buffer locations (45, 45′) and step i) is repeated for articles (3) of different article types, wherein the articles (3) are buffered at the buffer locations (45, 45′).
